(19) United States
(12) Patent Application Publication
(10) Pub. No.: US 2012/0147270 A1
(43) Pub. Date: Jun. 14, 2012

(54) NETWORK TELEVISION PROCESSING MULTIPLE APPLICATIONS AND METHOD FOR CONTROLLING THE SAME

(76) Inventors: Sangjeon KIM, Pyeongtaek-si (KR); Hanbitt Joo, Pyeongtaek-si (KR); Seonghwan Ryu, Pyeongtaek-si (KR)

(21) Appl. No.: 13/296,995

(22) Filed: Nov. 15, 2011

Related U.S. Application Data
(60) Provisional application No. 61/422,651, filed on Dec. 13, 2010.

(30) Foreign Application Priority Data
Dec. 23, 2010 (KR) 10-2010-0133283

(51) Int. Cl. H04N 5/445

(52) U.S. Cl. 348/564; 348/E05.099; 348/E05.103

(57) ABSTRACT

A display device receives first data indicative of a plurality of downloaded applications and then displays the first data in different areas on a screen corresponding respective ones of the applications. Also, second data is assigned to the applications, with the second data indicative of a different order or rank of the applications. The second data is displayed with the first data on the screen.

### CROSS-REFERENCE TO RELATED APPLICATIONS

Pursuant to 35 U.S.C. §119(e), This application claims the benefit of U.S. Provisional Application Ser. No. 61/422,651 filed on Dec. 13, 2010, which is hereby incorporated by references as if fully set forth herein.

Pursuant to 35 U.S.C. §119(a), This application also claims the benefit of the Korean Patent Application No. 10-2010-0133283 filed on Dec. 23, 2010, which is hereby incorporated by reference as if fully set forth herein.

### BACKGROUND

1. Field

One or more embodiments described herein relate to controlling the display of information.

2. Background

Televisions, monitors, and other types of image display devices receive various types of content including internet-based information, broadcast images, and games. These devices can also run applications downloaded through a network. Given the large number of available applications, one focus of system designers is to provide an efficient way of assisting users in managing and/or selecting downloaded applications to be executed. Even when the number of applications is not large, ways of conveniently and/or efficiently displaying applications for selection by viewers are of interest.

### BRIEF DESCRIPTION OF THE DRAWINGS

FIG. 1 shows one type of broadcast system with a display device.

FIG. 2 shows another type of broadcast system with display device.

FIG. 3 shows one way in which the display device in FIG. 1 or 2 may access a service provider and receive channel and other information.

FIG. 4 shows an example of data used in FIG. 3.

FIG. 5 shows one display device that may be used in FIG. 1 or 2.

FIG. 6 shows another display device that may be used in FIG. 1 or 2.

FIGS. 7 and 8 shows one example where the display device is provided separately from a set-top box. Of course, in other embodiments, the circuits and/or software for receiving network, programming, and other information may be included within the display device itself.

FIG. 9 shows an operation which may be performed for communicating with one or more third devices in a display device such as shown in FIG. 1 or 2.

FIG. 10 shows one type of controller that may be used in FIG. 6.

FIG. 11 shows a platform architecture for a display device in FIG. 1 or 2.

FIG. 12 shows another type of platform architecture for a display device.

FIG. 13 shows a remote controller for controlling a display device.

FIG. 14 shows another view of a remote controller for the display device.

FIG. 15 shows a first type of user interface for a display device.

FIG. 16 shows a second type of UI for a display device.

FIG. 17 shows a third type of UI for a display device.

FIG. 18 shows a fourth type of UI for a display device.

FIG. 19 shows an example of a Main Home screen of a network TV.

FIG. 20 shows an example of modules used in the network TV.

FIG. 21 to FIG. 23 show steps included in one method used for categorizing downloaded applications and for displaying the categorized applications in the network TV or another type of display device.

FIG. 24 shows a first screen for displaying downloaded applications.

FIG. 25 shows a second screen for displaying downloaded applications.

FIG. 26 shows a third screen for displaying downloaded applications.

FIG. 27 shows a fourth screen for displaying downloaded applications.

FIG. 28 shows a fifth screen for displaying downloaded applications.

FIG. 29 shows a sixth screen for displaying downloaded applications.

FIG. 30 shows a seventh screen for displaying downloaded applications.

FIG. 31 shows an embodiment of a method for controlling a network TV.

FIG. 32 illustrates a display device according to an exemplary embodiment of the invention.

### DETAILED DESCRIPTION

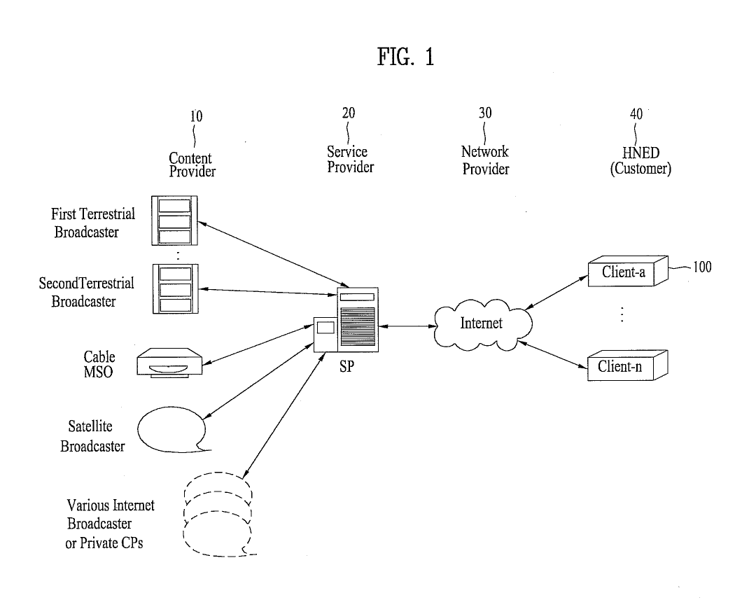

FIG. 1 shows one embodiment of a broadcast system with an image display device. This system may include a Content Provider (CP) 10, a Service Provider (SP) 20, a Network Provider (NP) 30, and a Home Network End Device (HNED) 40. The HNED 40 corresponds to, for example, a client 100 which is an image display device, which may be a network TV, a smart TV, an Internet Protocol TV (IPTV), as well as other types of TVs, monitors, and display devices. For convenience purposes, all of these devices are generically be referred to herein as a network TV.

The CP 10 creates and provides a variety of content. The CP 10 may be, for example, a terrestrial broadcaster, a cable System Operator (SO) or Multiple System Operator (MSO), a satellite broadcaster, or an Internet broadcaster, as in FIG. 1. Besides broadcast content, the CP 10 may provide various applications, which will be described later in detail.

The SP 20 may provide content received from the CP 10 as a service package. For instance, the SP 20 may package first terrestrial broadcasts, second terrestrial broadcasts, cable MSOs, satellite broadcasts, various Internet broadcasts, and applications and provide the package to users.

The SP 20 may unicast or multicast a service to the client 100. Unicast is a form of transmission in which data is sent from only one transmitter to only one receiver. In an example of unicast transmission, upon receipt of a request for data from a receiver, a server transmits the data to only one receiver. Multicast is a type of transmission or communication in which a transmitter transmits data to a group of receivers. For example, a server may transmit data to a plurality of pre-registered receivers at one time. For multicast registration, Internet Group Management Protocol (IGMP) may be used.

The NP 30 may provide a network over which a service is provided to the client 100. The client 100 may construct a home network end user (HNED) and receive a service over the HNED.

Content transmitted in the above-described system including the image display device may be protected through conditional access or content protection. CableCard and Downloadable Conditional Access System (DCAS) are examples of such conditional access or content protection systems.

The client 100 may also transmit content over a network. In this case, the client 100 serves as a CP and thus the CP 10 may receive content from the client 100. Therefore, an interactive content service or data service can be provided.

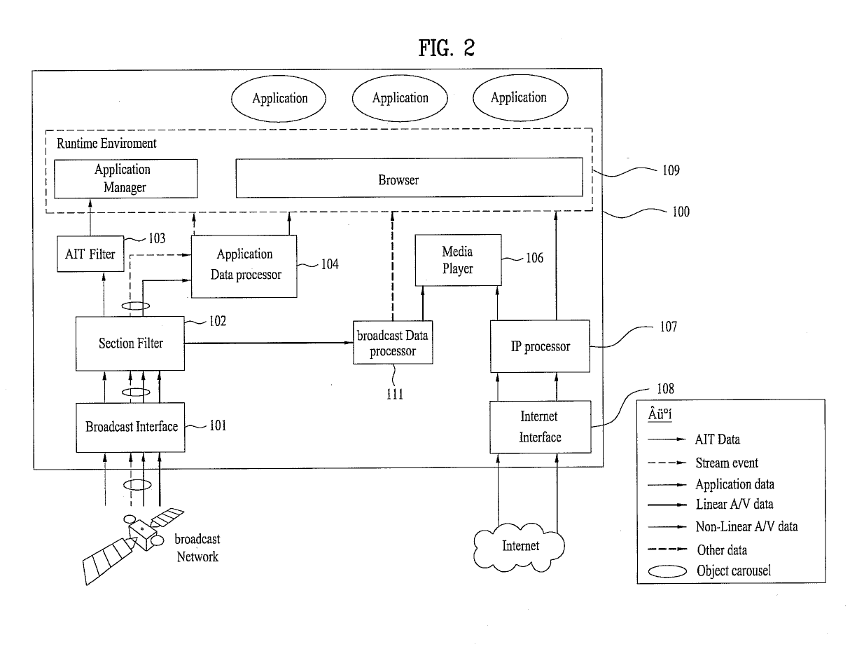

FIG. 2 illustrates the overall configuration of a broadcast system including an image display device according to another embodiment. As shown, the image display device 100 is connected to a broadcast network and the Internet. The image display device 100 is, for example, a network TV, a smart TV, an HBBTV, etc. Once again, these devices may be referred to as a network TV for convenience.

The image display device 100 includes, for example, a broadcast interface 101, a section filter 102, an Application Information Table (AIT) filter 103, an application data processor 104, a broadcast data processor 111, a media player 106, an Internet Protocol (IP) processor 107, an Internet interface 108, and a runtime module 109.

The image display device 100 receives AIT data, real-time broadcast content, application data, and stream events through the broadcast interface 101. The real-time broadcast content may be referred to as linear Audio/Video (A/V) content.

The section filter 102 performs section filtering on the four types of data received through the broadcast interface 101, and outputs the AIT data to the AIT filter 103, the linear A/V content to the broadcast data processor 111, and the stream events and application data to the application data processor 104.

Meanwhile, the image display device 100 receives non-linear A/V content and application data through the Internet interface 108. The non-linear A/V content may be, for example, a Content On Demand (CoD) application.

The non-linear A/V content and the application data are transmitted to the media player 106 and the runtime module 109, respectively.

The runtime module 109 includes, for example, an application manager and a browser as illustrated in FIG. 2. The application manager controls the life cycle of an interactive application using the AIT data, for example. The browser displays and processes the interactive application.

The game application according to one embodiment is received through the broadcast interface 101 or the Internet interface 108 shown in FIG. 2. The game application received through the broadcast interface 101 is transmitted to the runtime module 109 through the application data processor 104. The game application received through the Internet interface 108 is transmitted to the runtime module 109 through the IP processor 107. The runtime module 109 executes the game application.

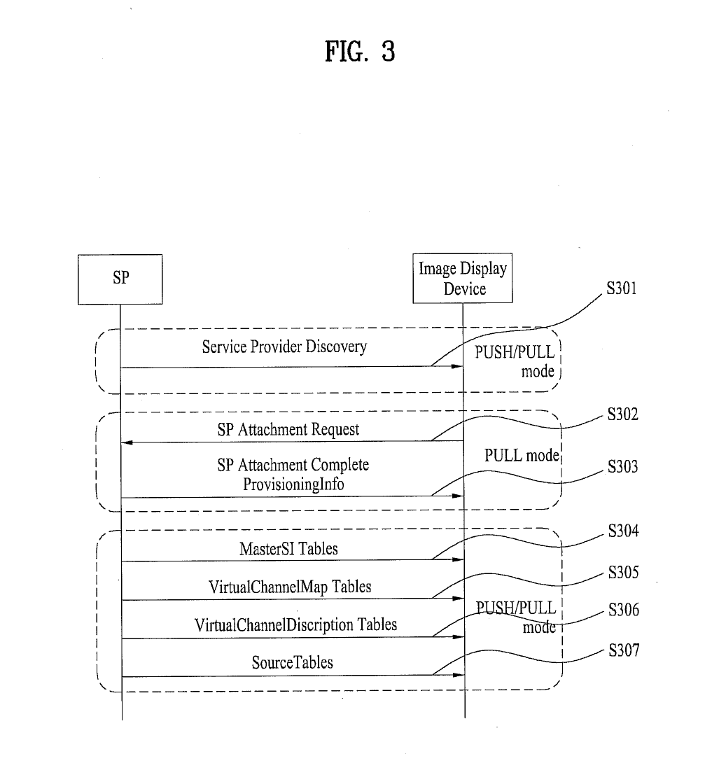

FIG. 3 is a diagram showing steps in one type of method in which the image display device in FIG. 1 or 2 accesses an SP and receives channel and other information.

In this diagram, the SP performs an SP discovery operation (S301). The image display device transmits an SP attachment request signal (S302). Upon completion of attachment to the SP, the image display device receives provisioning information from the SP (S303). Further, the image display device receives Master System Information (SI) Tables (S304), receives Virtual Channel Map Tables (S305), receives Virtual Channel Description Tables (S306), and receives Source Tables from the SP (S307). More specifically, SP Discovery is a process by which SPs that provide IPTV services search for servers providing services to the SPs.

In order to receive information (e.g., SP discovery information) about the service discovery (SD) servers, an SD server address list can be detected, for example, using three methods, specifically use of an address preset in the image display device or an address manually set by a user, Dynamic Host Configuration Protocol (DHCP)-based SP Discovery, and Domain Name System Service (DNS SRV)-based SP Discovery. The image display device accesses a specific SD server using the SD server address list obtained through one of the above three methods and receives an SP Discovery record from the specific SD server. The Service Provider Discovery record includes information needed to perform Service Discovery on an SP basis. The image display device then starts a Service Discovery operation using the SP Discovery record. These operations can be performed in a push mode or a pull mode.

The image display device accesses an SP attachment server specified by an SP attachment locator included in the SP Discovery record and performs a registration procedure (or a service attachment procedure). Further, after accessing an authentication service server of an SP specified by an SP authentication locator and performing an authentication procedure, the image display device may perform a service authentication procedure.

Once service attachment is successfully completed, a server may transmit data to the image display device in the form of a provision information table.

During service attachment, the image display device may include an Identifier (ID) and location information thereof in data and transmit the data to the service attachment server. Thus the service attachment server may specify a service that the image display device has subscribed to based on the ID and location information. In addition, the service attachment server provides, in the form of a provisioning information table, address information from which the image display device can obtain Service Information (SI). The address information corresponds to access information about a Master SI Table. This method facilitates provision of a customized service to each subscriber.

The SI is divided into a Master SI Table record for managing access information and version info nation about a Virtual Channel Map, a Virtual Channel Map Table for providing a list of services in the form of a package, a Virtual Channel Description Table that contains details of each channel, and a Source Table that contains access information about actual services.

The image display device shown in FIG. 3 receives the game application according to one embodiment from the SP or a virtual channel provided by a broadcast station.

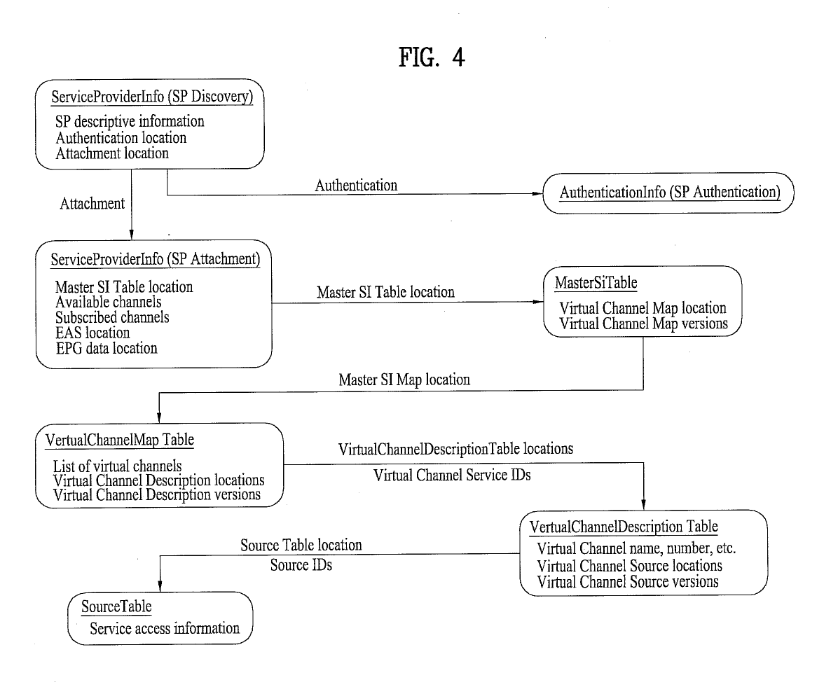

FIG. 4 is a diagram showing an example of data used in the steps shown in FIG. 3, and of a relationship that may exist among data in the SI. In this example, a Master SI Table may contain information about the location and version of each Virtual Channel MAP.

Each Virtual Channel MAP is identified by its Virtual Channel MAP identifier. Virtual Channel MAP Version specifies the version number of the Virtual Channel MAP. If any of the tables connected to the Master SI Table shown in FIG. 4 in the arrowed direction is modified, the versions of the modified table and overlying tables thereof (up to the Master SI Table) are incremented. Accordingly, a change in any of the SI tables can be readily identified by monitoring the Master SI Table.

For example, when the Source Table is changed, the version of the Source Table is incremented and the version of the Virtual Channel Description Table that references the Source Table is also incremented. In conclusion, a change in any lower table leads to a change in its higher tables and, eventually, a change in the Master SI Table.

One Master SI Table may exist for each SP. However, in the case where service configurations differ for regions or subscribers (or subscriber groups), an SP may have a plurality of Master SI Tables in order to provide a customized service on a unit basis. Thus it is possible to efficiently provide a customized service to a subscriber through the master SI table according to a region in which the subscriber is located and subscriber information regarding the subscriber.

A Virtual Channel Map Table may contain one or more virtual channels. A Virtual Channel Map includes not only details of the channels but information about the locations of the details of the channels. In the Virtual Channel Map Table, Virtual Channel Description Location specifies the location of a Virtual Channel Description Table including the details of the channels.

The Virtual Channel Description Table contains the details of the virtual channels. The Virtual Channel Description Table can be accessed using the Virtual Channel Description Location of the Virtual Channel Map Table.

A Source Table provides information necessary to access actual services (e.g. IP addresses, ports, AV Codecs, transmission protocols, etc.) on a service basis.

The above-described Master SI Table, the Virtual Channel Map Table, the Virtual Channel Description Table and the Source Table are delivered in four logically separate flows, in a push mode or a pull mode. For version management, the Master SI Table may be multicast and thus version changes can be monitored by receiving a multicast stream.

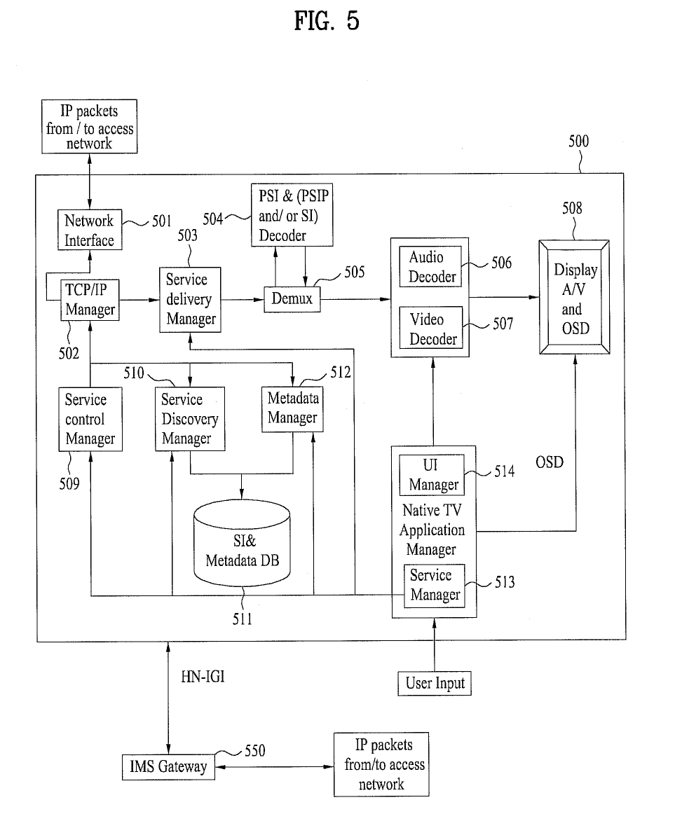

FIG. 5 is a diagram of one configuration of a image display device 500 as shown in FIG. 1 or 2. The structure of the image display device in FIG. 5 is purely exemplary and should not be interpreted as limiting the scope of the present invention.

The image display device 500 includes a network interface 501, a Transmission Control Protocol/Internet Protocol (TCP/IP) manager 502, a service delivery manager 503, a demultiplexer (DEMUX) 505, a Program Specific Information (PSI) & (Program and System Information Protocol (PSIP) and/or SI) decoder 504, an audio decoder 506, a video decoder 507, a display A/V and OSD module 508, a service control manager 509, a service discovery manager 510, a metadata manager 512, an SI & metadata database (DB) 511, a User Interface (UI) manager 514, and a service manager 513.

The network interface 501 transmits packets to and receives packets from a network. More specifically, the network interface 501 receives services and content from an SP over the network.

The TCP/IP manager 502 is involved in packet reception and transmission of the image display device 500, that is, packet delivery from a source to a destination. The TCP/IP manager 502 classifies received packets according to appropriate protocols and outputs the classified packets to the service delivery manager 505, the service discovery manager 510, the service control manager 509, and the metadata manager 512.

The service delivery manager 503 controls reception of service data. For example, when controlling real-time streaming data, the service delivery manager 503 may use the Real-time Transport Protocol/Real-time Transport Control Protocol (RTP/RTCP). If real-time streaming data is transmitted over RIP, the service delivery manager 503 parses the received real-time streaming data using RTP and transmits the parsed real-time streaming data to the DEMUX 505 or stores the parsed real-time streaming data in the SI & metadata DB 511 under the control of the service manager 513. In addition, the service delivery manager 503 feeds back network reception information to a server that provides the service using RTCP.

The DEMUX 505 demultiplexes a received packet into audio data, video data and PSI data and transmits the audio data, video data and PSI data to the audio decoder 506, the video decoder 507, and the PSI & (PSIP and/or SI) decoder 504, respectively.

The PSI & (PSIP and/or SI) decoder 504 decodes SI such as PSI. More specifically, the PSI & (PSIP and/or SI) decoder 504 receives and decodes PSI sections, PSIP sections or SI sections demultiplexed by the DEMUX 505. The PSI & (PSIP and/or SI) decoder 504 constructs an SI DB by decoding the received sections and stores the SI DB in the SI & metadata DB 511.

The audio decoder 506 and the video decoder 507 decode the audio data and the video data received from the DEMUX 505 and output the decoded audio and video data to a user through the display A/V and OSD module 508.

The UI manager 514 and the service manager 513 manage the overall state of the image display device 500, provide UIs, and manage other managers. The UI manager 514 provides a Graphical User Interface (GUI) in the form of an OSD and performs a reception operation corresponding to a key input received from the user. For example, upon reception of a key input signal regarding channel selection from the user, the UI manager 514 transmits the key input signal to the service manager 513.

The service manager 513 controls managers associated with services, such as the service delivery manager 503, the service discovery manager 510, the service control manager 509, and the metadata manager 512.

The service manager 513 also creates a channel map and selects a channel using the channel map according to the key input signal received from the UI manager 514. The service manager 513 sets the audio/video Packet ID (PID) of the selected channel based on SI of the channel received from the PSI & (PSIP and/or SI) decoder 504 in the demultiplexer 505.

The service discovery manager 510 provides information necessary to select an SP that provides a service. Upon receipt of a channel selection signal from the service manager 513, the service discovery manager 510 detects a service based on the channel selection signal.

The service control manager 509 takes charge of selection and control services. For example, if a user selects a live broadcasting service, such as a conventional broadcasting service, the service control manager selects and controls the service using Internet Group Management Protocol (IGMP) or Real-Time Streaming Protocol (RTSP). If the user selects Video on Demand (VoD), the service control manager 509 selects and controls the service using RTSP.

RTSP supports trick mode for real-time streaming. Further, the service control manager 509 may initialize and manage a session through an IP Multimedia Control (IMC) gateway using IP Multimedia Subsystem (IMS) and Session Initiation Protocol (SIP). The protocols are only exemplary and thus other protocols are also applicable.

The metadata manager 512 manages metadata related to services and stores the metadata in the SI & metadata DB 511.

The SI & metadata DB 511 stores the SI decoded by the PSI & (PSIP and/or SI) decoder 504, the metadata managed by the metadata manager 512, and the information required to select an SP, received from the service discovery manager 510. The SI & metadata DB 511 may store system setup data.

The SI & metadata DB 511 may be constructed in a Non-Volatile RAM (NVRAM) or a flash memory.

An IMS Gateway (IG) 550 is a gateway equipped with functions needed to access IMS-based IPTV services.

The UI manager 514 of the image display device 500 shown in FIG. 5 serves to control the game application according to the one embodiment. In particular, the UI manager 514 operates according to a user input signal.

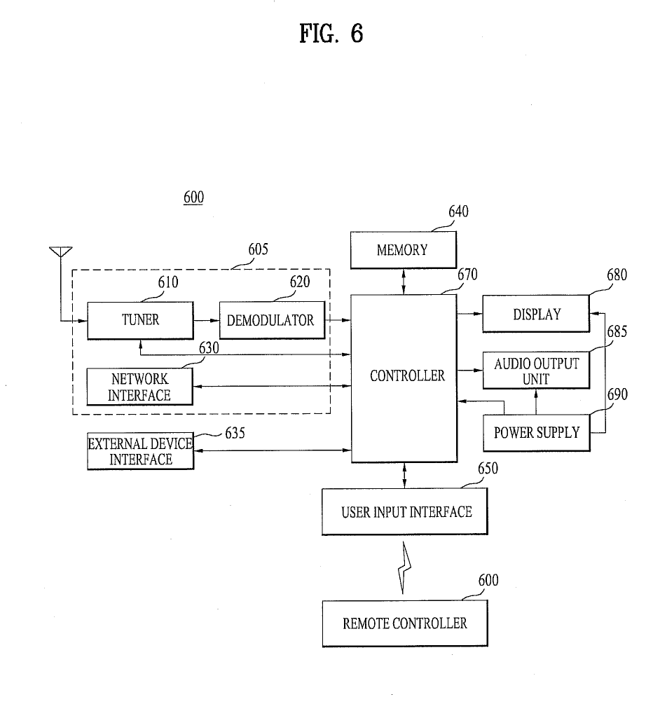

FIG. 6 is a diagram of another configuration of a image display device 600 that may be used in FIG. 1 or 2. The image display device 600 includes a broadcast receiver 605, an external device interface 635, a memory 640, a user input interface 650, a controller 670, a display 680, an audio output unit 685, a power supply 690, and a camera module (not shown). The broadcasting receiver 605 may include a tuner 610, a demodulator 620 and a network interface 630. As needed, the broadcasting receiver 605 may be configured so as to include only the tuner 610 and the demodulator 620 or only the network interface 630.

The tuner 610 tunes to a Radio Frequency (RF) broadcast signal corresponding to a channel selected by a user from among a plurality of RF broadcast signals received through an antenna and downconverts the tuned RF broadcast signal into a digital Intermediate Frequency (IF) signal or an analog baseband video or audio signal.

More specifically, if the tuned RF broadcast signal is a digital broadcast signal, the tuner 610 downconverts the tuned RF broadcast signal into a digital IF signal DIF. On the other hand, if the tuned RF broadcast signal is an analog broadcast signal, the tuner 610 downconverts the tuned RF broadcast signal into an analog baseband video or audio signal CVBS/SIF. That is, the tuner 610 may be a hybrid tuner capable of processing not only digital broadcast signals but also analog broadcast signals. The analog baseband video or audio signal CVBS/SIF may be directly input to the controller 670.

The tuner 610 may be capable of receiving RF broadcast signals from an Advanced Television Systems Committee (ATSC) single-carrier system or from a Digital Video Broadcasting (DVB) multi-carrier system.

The tuner 610 may sequentially tune to a number of RF broadcast signals corresponding to all broadcast channels previously stored by a channel storage function from a plurality of RF signals received through the antenna and may downconvert the tuned RF broadcast signals into IF signals or baseband video or audio signals.

The demodulator 620 receives the digital IF signal DIF from the tuner 610 and demodulates the digital IF signal DIF. For example, if the digital IF signal DIF is an ATSC signal, the demodulator 620 may perform 8-Vestigal SideBand (VSB) demodulation on the digital IF signal DIF. The demodulator 620 may also perform channel decoding.

For channel decoding, the demodulator 620 may include a Trellis decoder (not shown), a de-interleaver (not shown) and a Reed-Solomon decoder (not shown) so as to perform Trellis decoding, de-interleaving and Reed-Solomon decoding.

For example, if the digital IF signal DIF is a DVB signal, the demodulator 620 performs Coded Orthogonal Frequency Division Multiple Access (COFDMA) demodulation upon the digital IF signal DIF. The demodulator 620 may also perform channel decoding. For channel decoding, the demodulator 620 may include a convolution decoder (not shown), a de-interleaves (not shown), and a Reed-Solomon decoder (not shown) so as to perform convolution decoding, de-interleaving, and Reed-Solomon decoding.

The demodulator 620 may perform demodulation and channel decoding on the digital IF signal DIF, thereby obtaining a Transport Stream (TS). The TS may be a signal in which a video signal, an audio signal and a data signal are multiplexed. For example, the TS may be an MPEG-2 TS in which an MPEG-2 video signal and a Dolby AC-3 audio signal are multiplexed. An MPEG-2 TS may include a 4-byte header and a 184-byte payload. In order to properly handle not only ATSC signals but also DVB signals, the demodulator 620 may include an ATSC demodulator and a DVB demodulator.

The TS output from the demodulator 620 may be input to the controller 670 and thus subjected to demultiplexing and A/V signal processing. The processed video and audio signals are output to the display 680 and the audio output unit 685, respectively.

The external device interface 635 may serve as an interface between an external device and the image display device 600. For interfacing, the external device interface 635 may include an A/V Input/Output (I/O) unit (not shown) and/or a wireless communication module (not shown).

The external device interface 635 may be connected to an external device such as a Digital Versatile Disc (DVD) player, a Blu-ray player, a game console, a camera, a camcorder, or a computer (e.g., a laptop computer), wirelessly or by wire. Then, the external device interface 635 externally receives video, audio, and/or data signals from the external device and transmits the received input signals to the controller 670. In addition, the external device interface 635 may output video, audio, and data signals processed by the controller 670 to the external device. In order to receive or transmit audio, video and data signals from or to the external device, the external device interface 635 includes the A/V I/O unit (not shown) and/or the wireless communication module (not shown).

The A/V I/O unit may include a Universal Serial Bus (USB) port, a Composite Video Banking Sync (CVBS) port, a Component port, a Super-video (S-video) (analog) port, a Digital Visual Interface (DVI) port, a High-Definition Multimedia Interface (HDMI) port, a Red-Green-Blue (RGB) port, and a D-sub port, in order to input the video and audio signals of the external device to the image display device 600.

The wireless communication module may perform short-range wireless communication with other electronic devices. For short-range wireless communication, the wireless communication module may use Bluetooth, Radio-Frequency IDentification (RFID), Infrared Data Association (IrDA), Ultra WideBand (UWB), ZigBee, and Digital Living Network Affiance (DLNA) communication standards.

The external device interface 635 may be connected to various set-top boxes through at least one of the above-described ports and may thus perform an I/O operation with the various set-top boxes.

The external device interface 635 may receive applications or an application list from an adjacent external device and provide the applications or the application list to the controller 670 or the memory 640.

The network interface 630 serves as an interface between the image display device 600 and a wired/wireless network such as the Internet. The network interface 630 may include an Ethernet port for connection to a wired network. For connection to wireless networks, the network interface 630 may use Wireless Local Area Network (WLAN) (i.e., Wi-Fi), Wireless Broadband (WiBro), World Interoperability for Microwave Access (WiMax), and High Speed Downlink Packet Access (HSDPA).

The network interface 630 may transmit data to or receive data from another user or electronic device over a connected network or another network linked to the connected network. Especially, the network interface 630 may transmit data stored in the image display device 600 to a user or electronic device selected from among users or electronic devices pre-registered with the image display device 600.

The network interface 630 may access a specific Web page over a connected network or another network linked to the connected network. That is, the network interface 630 may access a specific Web page over a network and transmit or receive data to or from a server. Additionally, the network interface 630 may receive content or data from a CP or an NP. Specifically, the network interface 630 may receive content such as movies, advertisements, games, VoD, and broadcast signals, and information related to the content from a CP or an NP. Also, the network interface 630 may receive update information about firmware from the NP and update the firmware. The network interface 630 may transmit data over the Internet or to the CP or the NP.

The network interface 630 may selectively receive a desired application among open applications over a network. In one embodiment, when a game application is executed in the image display device, the network interface 630 may transmit data to or receive data from a user terminal connected to the image display device through a network. In addition, the network interface 630 may transmit specific data to or receive specific data from a server that records game scores.

The memory 640 may store various programs necessary for the controller 670 to process and control signals, and may also store processed video, audio and data signals. The memory 640 may temporarily store a video, audio and/or data signal received from the external device interface 635 or the network interface 630. The memory 640 may store information about broadcast channels by the channel storage function.

Also, the memory 640 may store applications or a list of applications received from the external device interface 135 or the network interface 630. The memory 640 may store a variety of platforms which will be described later.

In one embodiment, when the image display device provides a game application, the memory 640 may store user-specific information and game play information of a user terminal used as a game controller.

The memory 640 may include, for example, at least one of a flash memory-type storage medium, a hard disk-type storage medium, a multimedia card micro-type storage medium, a card-type memory (e.g. a Secure Digital (SD) or eXtreme Digital (XD) memory), a Random Access Memory (RAM), or a Read-Only Memory (ROM) such as an Electrically Erasable and Programmable Read Only Memory (EEPROM). The image display device 600 may reproduce content stored in the memory 640 (e.g. video, still image, music, text, and/or application files) to the user.

While the memory 640 is shown in FIG. 6 as configured separately from the controller 670, to which the present invention is not limited, the memory 640 may be incorporated into the controller 670, for example.

The user input interface 650 transmits a signal received from the user to the controller 670 or transmits a signal received from the controller 670 to the user. For example, the user input interface 650 may receive control signals such as a power-on/off signal, a channel selection signal, and a screen setting signal from a remote controller 611 or may transmit a control signal received from the controller 670 to the remote controller 611, according to various communication schemes, for example, RF communication and IR communication.

For example, the user input interface 650 may provide the controller 670 with control signals received from local keys (not shown), such as inputs of a power key, a channel key, and a volume key, and setting values.

Also, the user input interface 650 may transmit a control signal received from a sensor unit (not shown) for sensing a user gesture to the controller 670 or transmit a signal received from the controller 670 to the sensor unit. The sensor unit may include a touch sensor, a voice sensor, a position sensor, a motion sensor, etc.

The controller 670 may demultiplex the TS received from the tuner 610, the demodulator 620, or the external device interface 635 into a number of signals and process the demultiplexed signals into audio and video data.

The video signal processed by the controller 670 may be displayed as an image on the display 680. The video signal processed by the controller 670 may also be transmitted to an external output device through the external device interface 635.

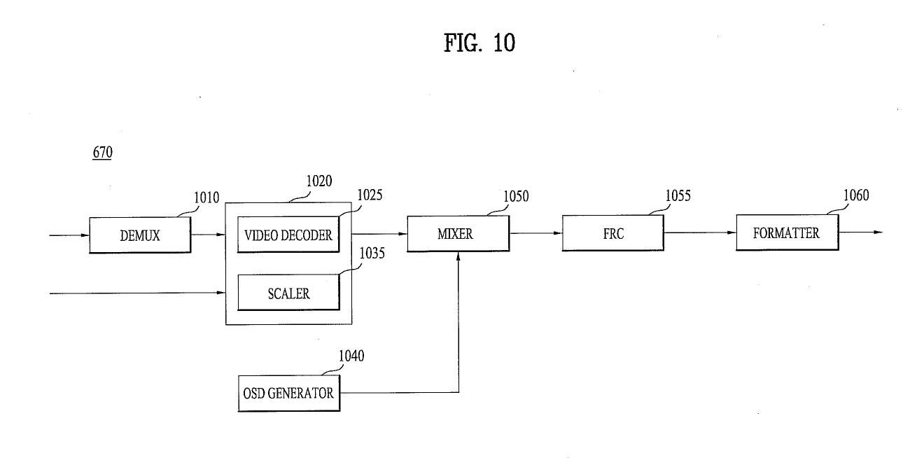

The audio signal processed by the controller 670 may be audibly output through audio output unit 685. Also, the audio signal processed by controller 670 may be transmitted to the external output device through the external device interface 635. While not shown in FIG. 6, the controller 670 may include a DEMUX and a video processor, which will be described later with reference to FIG. 10.

In addition, the controller 670 may provide overall control to the image display device 600. For example, the controller 670 may control the tuner 610 to tune to an RF broadcast signal corresponding to a user-selected channel or a pre-stored channel.

The controller 670 may control the image display device 600 according to a user command received through the user input interface 650 or according to an internal program. Especially the controller 670 may access a network and download an application or application list selected by the user to the image display device 600 over the network.

For example, the controller 670 controls the tuner 610 to receive a signal of a channel selected according to a specific channel selection command received through the user input interface 650 and processes a video, audio and/or data signal of the selected channel. The controller 670 outputs the processed video or audio signal along with information about the user-selected channel to the display 680 or the audio output unit 685.

As another example, the controller 670 outputs a video or audio signal received from an external device such as a camera or a camcorder through the external device interface 635 to the display 680 or the audio output unit 685 according to an external device video playback command received through external device interface 650.

The controller 670 may control the display 680 to display images. For instance, the controller 670 may control the display 680 to display a broadcast image received from the tuner 610, an externally input image received through the external device interface 635, an image received through the network interface 630, or an image stored in the memory 640. The image displayed on the display 680 may be a Two-Dimensional (2D) or Three-Dimensional (3D) still image or moving picture.

The controller 670 may control content playback. The content may include any content stored in the image display device 600, received broadcast content, and externally input content. The content includes at least one of a broadcast image, an externally input image, an audio file, a still image, a Web page, or a text file.

Upon receipt of a return-to-home screen input, the controller 670 may control display of the home screen on the display 680. The home screen may include a plurality of card objects classified according to content sources. The card objects may include at least one of a card object representing a thumbnail list of broadcast channels, a card object representing a broadcast program guide, a card object representing a program reservation list or a program recording list, or a card object representing a media list of a device connected to the image display device.

The card objects may further include at least one of a card object representing a list of connected external devices or a card object representing a call-associated list.

The home screen may further include an application menu including at least one application that can be executed. Accordingly, the game application according to the one embodiment may be designed in a format selectable through the application menu of the above-described home screen. Further, in the present invention, user convenience may be improved by adding or deleting the game application to or from the application menu according to user selection.

Upon receipt of a card object move input, the controller 670 may control movement of a card object corresponding to the card object move input on the display 680, or if the card object is not displayed on the display 680, the controller 670 may control display of the card object on the display 680.

When a card object is selected from among the card objects on the home screen, the controller 670 may control display of an image corresponding to the selected card object on the display 680.

The controller 670 may control display of an input broadcast image and an object representing information about the broadcast image in a card object representing broadcast images. The size of the broadcast image may be set to a fixed size.

The controller 670 may control display of a set-up object for at least one of image setting, audio setting, screen setting, reservation setting, setting of a pointer of the remote controller, or network setting on the home screen.

The controller 670 may control display of a log-in object, a help object, or an exit object on a part of the home screen. Also, controller 670 may control display of an object representing the total number of available card objects or the number of card objects displayed on display 680 among all card objects, on a part of the home screen. If one of the card objects displayed on the display 680 is selected, controller 670 may fullscreen the selected card object to cover the entirety of the display 680.

Upon receipt of an incoming call at a connected external device or the image display device 600, the controller 670 may control focusing-on or shift of a call-related card object among the plurality of card objects.

If an application view menu item is selected, the controller 670 may control display of applications or a list of applications that are present in the image display device 600 or downloadable from an external network.

The controller 670 may control installation and execution of an application downloaded from the external network along with various UIs.

Also, the controller 670 may control display of an image related to the executed application on the display 680, upon user selection.

In one embodiment, when the image display device provides a game application, the controller 670 may control assignment of player IDs to specific user terminals, creation of game play information by executing the game application, transmission of the game play information corresponding to the player IDS assigned to the user terminals through the network interface 630, and reception of the game play information at the user terminals.

The controller 670 may control detection of user terminals connected to the image display device over a network through the network interface 630, display of a list of the detected user terminals on the display 680 and reception of a selection signal indicating a user terminal selected for use as a user controller from among the detected user terminals through the user input interface 650.

The controller 670 may control output of a game play screen of the game application, inclusive of player information of each user terminal and game play information, through the display 680.

The controller 670 may determine the specific signal received from a user terminal through the network interface 630 as game play information and thus control the game play information to be reflected in the game application in progress.

The controller 670 may control transmission of the game play information of the game application to a specific server connected over a network through the network interface 630.

In another embodiment, upon receipt of information about a change in the game play information from a predetermined server through the network interface 630, the controller 670 may control output of a notification message in a predetermined area of the display 680.

Although not shown, the image display device 600 may further include a channel browsing processor for generating thumbnail images corresponding to channel signals or externally input signals.

The channel browsing processor may receive the TS output from the demodulator 620 or the TS output from the external device interface 635, extract images of the received TS and generate thumbnail images. The thumbnail images may be directly output to the controller 670 or may be output after being encoded. Also, it is possible to encode the thumbnail images into a stream and output the stream to the controller 670. The controller 670 may display a thumbnail list including a plurality of received thumbnail images on the display 680. The thumbnail images may be updated sequentially or simultaneously in the thumbnail list. Therefore, the user can readily identify the content of broadcast programs received through a plurality of channels.

The display 680 may convert a processed video signal, a processed data signal, and an OSD signal received from the controller 670 or a video signal and a data signal received from the external device interface 635 into RGB signals, thereby generating driving signals. The display 680 may be various types of displays such as a Plasma Display Panel (PDP), a Liquid Crystal Display (LCD), an Organic Light-Emitting Diode (OLED) display, a flexible display, and a 3D display. The display 680 may also be a touchscreen that can be used not only as an output device but also as an input device.

The audio output unit 685 may receive a processed audio signal (e.g., a stereo signal, a 3.1-channel signal or a 5.1-channel signal) from the controller 670 and output the received audio signal as sound. The audio output unit 685 may employ various speaker configurations.

To sense a user gesture, the image display device 600 may further include the sensor unit (not shown) that has at least one of a touch sensor, a voice sensor, a position sensor, and a motion sensor, as stated before. A signal sensed by the sensor unit may be output to the controller 670 through the user input interface 650.

The image display device 600 may further include the camera unit (not shown) for capturing images of a user. Image information captured by the camera unit may be input to the controller 670. The controller 670 may sense a user gesture from an image captured by the camera unit or a signal sensed by the sensor unit, or by combining the captured image and the sensed signal.

The power supply 690 supplies power to the image display device 600. Particularly, the power supply 690 may supply power to the controller 670 which may be implemented as a System On Chip (SOC), the display 680 for displaying an image, and the audio output unit 685 for audio output.

For supplying power, the power supply 690 may include a converter (not shown) for converting Alternating Current (AC) into Direct Current (DC). If the display 680 is configured with, for example, a liquid crystal panel having a plurality of backlight lamps, the power supply 690 may further include an inverter (not shown) capable of performing Pulse Width Modulation (PWM) for luminance change or dimming driving.

The remote controller 611 transmits a user input to the user input interface 650. For transmission of user input, the remote controller 611 may use various communication techniques such as Bluetooth, RF communication, IR communication, Ultra Wideband (UWB) and ZigBee.

In addition, the remote controller 611 may receive a video signal, an audio signal or a data signal from the user input interface 650 and output the received signals visually, audibly or as vibrations.

The above-described image display device 600 may be a fixed digital broadcast receiver capable of receiving at least one of ATSC (8-VSB) broadcast programs, DVB-T (COFDM) broadcast programs, and ISDB-T (BST-OFDM) broadcast programs.

The block diagram of the image display device 600 illustrated in FIG. 6 is purely exemplary. Depending upon the specifications of the image display device 600 in actual implementation, the components of the image display device 600 may be combined or omitted or new components may be added. That is, two or more components may be incorporated into one component or one component may be configured as separate components. In addition, the function of each block is described for the purpose of describing the one embodiment and thus specific operations or devices should not be construed as limiting the scope and spirit of the present invention.

Unlike the configuration illustrated in FIG. 6, the image display device 600 may be configured so as to receive and play back video content through the network interface 630 or the external device interface 635, without the tuner 600 and the demodulator 620 shown in FIG. 6.

The game application according to the one embodiment is received through the network interface 630 of the image display device 600 shown in FIG. 6. Further, the received game application is stored in the memory 640.

The network interface 630 performs communication with a mobile device executing the above-described game application.

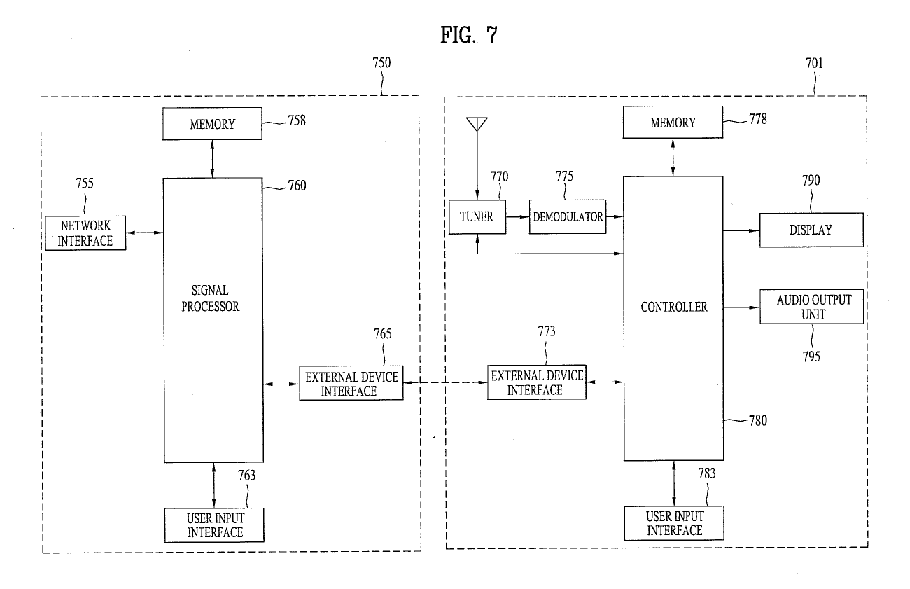

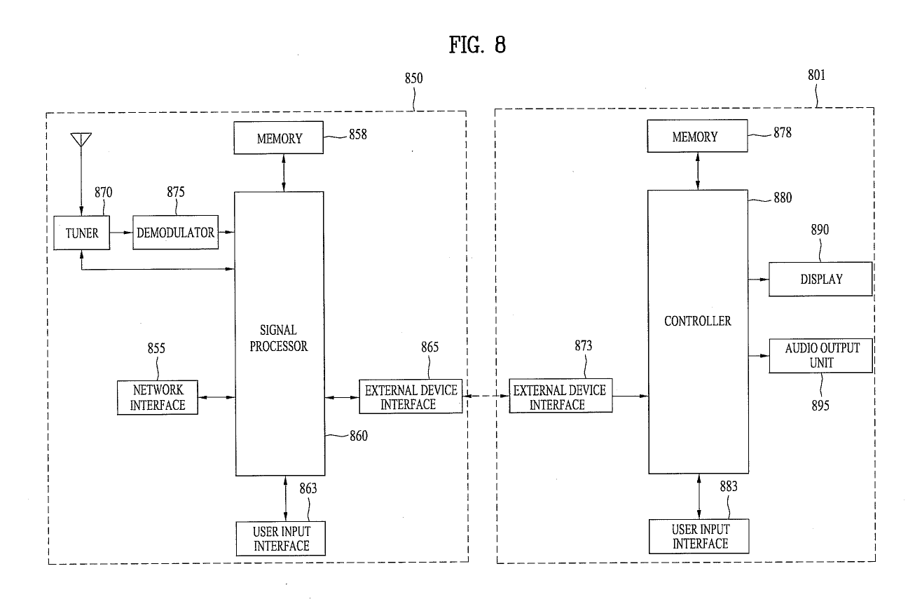

The image display device 600 is an exemplary image signal processing device that processes a stored image or an input image. Other examples of the image signal processing device include a set-top box without the display 680 and the audio output unit 685, a DVD player, a Blu-ray player, a game console, and a computer. The set-top box will be described later with reference to FIGS. 7 and 8.

FIGS. 7 and 8 are diagrams illustrating any one of the image display devices provided separately from a set-top box according to one or more embodiments.

Referring to FIG. 7, a set-top box 750 and a display device 701 may transmit or receive data wirelessly or by wire. The set-top box 750 may include a network interface 755, a memory 758, a signal processor 760, a user input interface 763, and an external device interface 765.

The network interface 755 serves as an interface between the set-top box 750 and a wired/wireless network such as the Internet. The network interface 755 may transmit data to or receive data from another user or another electronic device over a connected network or over another network linked to the connected network.

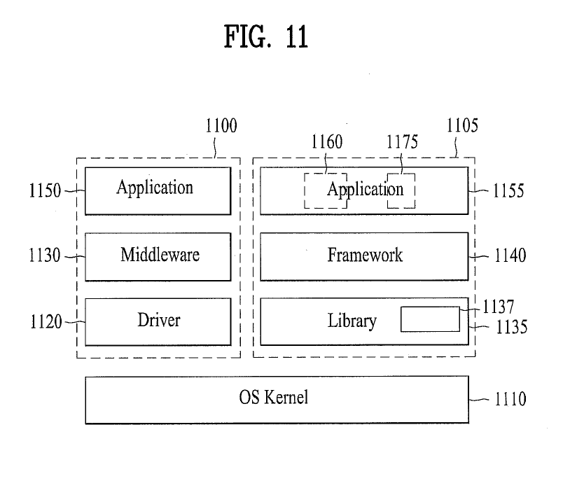

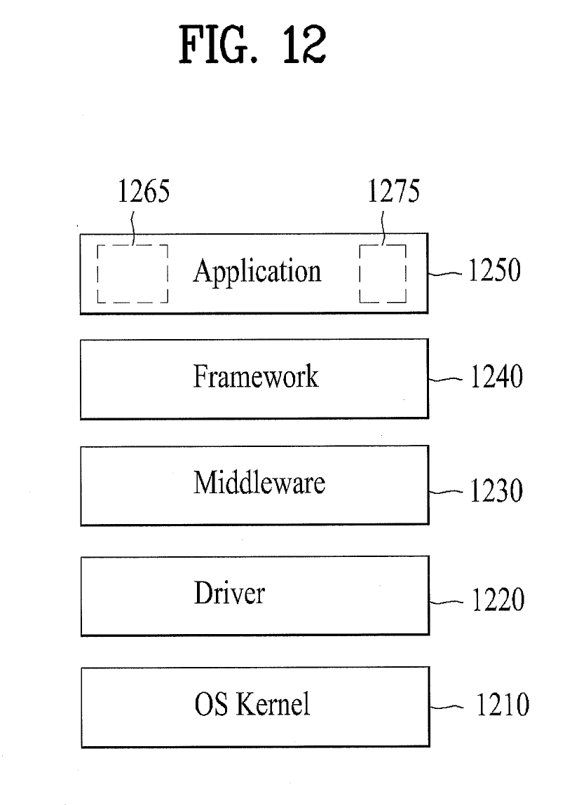

The memory 758 may store programs necessary for the signal processor 760 to process and control signals and temporarily store a video, audio and/or data signal received from the external device interface 765 or the network interface 755. The memory 758 may also store platforms shown in FIGS. 11 and 12, as described later.

The signal processor 760 processes an input signal. For example, the signal processor 760 may demultiplex or decode an input video or audio signal. For signal processing, the signal processor 760 may include a video decoder or an audio decoder. The processed video or audio signal may be transmitted to the display device 701 through the external device interface 265.

The user input interface 763 transmits a signal received from the user to the signal processor 760 or a signal received from the signal processor 760 to the user. For example, the user input interface 763 may receive various control signals such as a power on/off signal, an operation input signal, and a setting input signal through a local key (not shown) or the remote controller and output the control signals to the signal processor 760.

The external device interface 765 serves as an interface between the set-top box 750 and an external device that is connected wirelessly or by wire, particularly the display device 701, for data transmission or reception. The external device interface 765 may also interface with an external device such as a game console, a camera, a camcorder, and a computer (e.g. a laptop computer), for data transmission or reception.

The set-top box 750 may further include a media input unit for media playback. The media input unit may be a Blu-ray input unit (not shown), for example. That is, the set-top box 750 may include a Blu-ray player. After signal processing such as demultiplexing or decoding in the signal processor 760, a media signal from a Blu-ray disc may be transmitted to the display device 701 through the external device interface 765 so as to be displayed on the display device 701.

The display device 701 may include a tuner 770, an external device interface 773, a demodulator 775, a memory 778, a controller 780, a user input interface 783, a display 790, and an audio output unit 795.

The tuner 770, the demodulator 775, the memory 778, the controller 780, the user input interface 783, the display 790 and the audio output unit 795 are identical respectively to the tuner 610, the demodulator 620, the memory 640, the controller 670, the user input interface 650, the display 680, and the audio output unit 685 illustrated in FIG. 6 and thus a description thereof is not provided herein.

The external device interface 773 serves as an interface between the display device 701 and a wireless or wired external device, particularly the set-top box 750, for data transmission or reception. Hence, a video signal or an audio signal received through the set-top box 750 is output through the display 790 or through the audio output unit 795 under control of the controller 780.

Referring to FIG. 8, the configuration of the set-top box 850 and the display device 801 shown in FIG. 8 is similar to that of the set-top box 750 and the display device 701 shown in FIG. 7, except that the tuner 870 and the demodulator 875 reside in the set-top box 850, not in the display device 801. Thus the following description will focus upon such difference.

The signal processor 860 may process a broadcast signal received through the tuner 870 and the demodulator 875. The user input interface 863 may receive a channel selection input, a channel store input, etc.

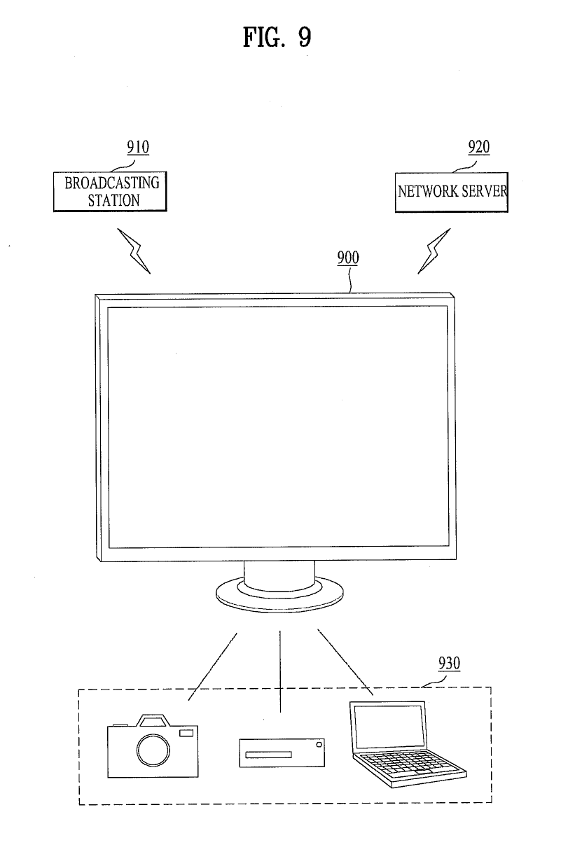

FIG. 9 is a diagram illustrating an operation for communicating with one or more third devices. The operation may be performed in an image display device, including but not limited to any of the embodiments of the image display devices described herein.

As shown in FIG. 9, an image display device 900 may communicate with a broadcast station 910, a network server 920, or an external device 930. The image display device 900 may receive a broadcast signal including a video signal from the broadcast station 910. The image display device 900 may process the audio and video signals of the broadcast signal or the data signal of the broadcast signal, suitably for output from the image display device 900. The image display device 900 may output video or audio based on the processed video or audio signal.

Meanwhile, the image display device 900 may communicate with the network server 920. The network server 920 is capable of transmitting signals to and receiving signals from the image display device 900 over a network.

For example, the network server 920 may be a portable terminal that can be connected to the image display device 900 through a wired or wireless base station. In addition, the network server 920 may provide content to the image display device 900 over the Internet. A CP may provide content to the image display device 900 through the network server.

The image display device 900 may communicate with the external device 930. The external device 930 can transmit and receive signals directly to and from the image display device 900 wirelessly or by wire. For instance, the external device 930 may be a media storage or player. That is, the external device 930 may be any of a camera, a DVD player, a Blu-ray player, a PC, etc.

The broadcast station 910, the network server 920 or the external device 930 may transmit a signal including a video signal to the image display device 900. The image display device 900 may display an image based on the video signal included in the received signal. Also, the image display device 900 may transmit a signal transmitted from the network server 920 to the broadcast station 910 to the external device 930 and may transmit a signal transmitted from the external device 930 to the image display device 900 to the broadcast station 910 or the network server 920. That is, the image display device 900 may transmit content included in signals received from the broadcast station 910, the network server 920, and the external device 930 or may immediately play back the content.

FIG. 10 is a block diagram of one type of controller used in FIG. 6. This controller 670 may include a DEMUX 1010, a video processor 1020, an OSD generator 1040, a mixer 1050, a Frame Rate Converter (FRC) 1055, and a formatter 1060 according to one embodiment. The controller 670 may further include an audio processor (not shown) and a data processor (not shown).

The DEMUX 1010 demultiplexes an input stream. For example, the DEMUX 1010 may demultiplex an MPEG-2 TS into a video signal, an audio signal, and a data signal. The stream signal input to the DEMUX 1010 may be received from the tuner 610, the demodulator 620 or the external device interface 635.

The video processor 1020 may process the demultiplexed video signal. For video signal processing, the video processor 1020 may include a video decoder 1025 and a scaler 1035.

The video decoder 1025 decodes the demultiplexed video signal and the scaler 1035 scales the decoded video signal so that the video signal can be displayed on the display 680. The video decoder 1025 may be provided with decoders that operate based on various standards.

If the demultiplexed video signal is, for example, an MPEG-2 encoded video signal, the video signal may be decoded by an MPEG-2 decoder. On the other hand, if the video signal is an H.264-encoded DMB or DVB-handheld (DVB-H) signal, the video signal may be decoded by an H.264 decoder. The video signal decoded by the video processor 1020 is provided to the mixer 1050.

The OSD generator 1040 generates an OSD signal autonomously or according to user input. For example, the OSD generator 1040 may generate signals by which a variety of information is displayed as graphics or text on the display 680, based on control signals received from the user input interface 650. The generated OSD signal may include various data such as a UI screen, a variety of menu screens, widgets, icons, etc. of the image display device 600

For example, the OSD generator 1040 may generate a signal by which subtitles are displayed for a broadcast image or Electronic Program Guide (EPG)-based broadcasting information.

The mixer 1050 may mix the decoded video signal processed by the image processor with the OSD signal generated by the OSD generator 1040 and output the mixed signal to the formatter 1060. As the decoded broadcast video signal or the externally input signal is mixed with the OSD signal, an OSD may be overlaid on the broadcast image or the externally input image.

The FRC 1055 may change the frame rate of an input image signal. For example, a frame rate of 60 Hz is converted into a frame rate of 120 or 240 Hz. When the frame rate is to be changed from 60 Hz to 120 Hz, a first frame is inserted between the first frame and a second frame, or a predicted third frame is inserted between the first and second frames. If the frame rate is to be changed from 60 Hz to 240 Hz, three identical frames or three predicted frames are inserted between the first and second frames. It is also possible to maintain the frame rate of the input image without frame rate conversion.

The formatter 1060 changes the format of the signal received from the FRC 355 to suit the display 680. For example, the formatter 1060 may convert a received signal into an RGB data signal. The RGB signal may be output in the form of a Low Voltage Differential Signal (LVDS) or mini-LVDS.

The audio processor (not shown) of the controller 670 may process the demultiplexed audio signal. For audio signal processing, the audio processor (not shown) may have a plurality of decoders.

If the demultiplexed audio signal is a coded audio signal, the audio processor (not shown) of the controller 670 may decode the audio signal. For example, the demultiplexed audio signal may be decoded by an MPEG-2 decoder, an MPEG-4 decoder, an Advanced Audio Coding (AAC) decoder, or an AC-3 decoder. The audio processor (not shown) of the controller 670 may also adjust the bass, treble or volume of the audio signal.

The data processor (not shown) of the controller 670 may process the demultiplexed data signal. For example, if the demultiplexed data signal is an encoded data signal such as an Electronic Program Guide (EPG) which includes broadcast information specifying the start time, end time, etc. of scheduled broadcast programs of each channel, the controller 670 may decode the data signal. Examples of an EPG include ATSC-Program and System Information Protocol (PSIP) information and DVB-Service Information (SI).

ATSC-PSIP information or DVB-SI may be included in the header of the above-described TS, i.e., a 4-byte header of an MPEG-2 TS.

The block diagram of the controller 670 shown in FIG. 10 is one embodiment. Depending upon the specifications of the controller 670, the components of the controller 670 may be combined, or omitted. Or new components may be added to the controller 670.

FIG. 11 is a diagram showing one example of one type of platform architecture that may be used for any of the types of image display devices described herein, and FIG. 12 shows another example of a platform architecture. Either or each type of platform may have OS-based software to implement the above-described various operations.

Referring to FIG. 11, a platform for the image display device is of a separate type. The platform may be designed separately as a legacy system platform 1100 and a smart system platform 1105. An OS kernel 1110 may be shared between the legacy system platform 1100 and the smart system platform 405.

The legacy system platform 1100 may include a stack of a driver 1120, middleware 1130, and an application layer 1150 on the OS kernel 1110. On the other hand, the smart system platform 1105 may include a stack of a library 1135, a framework 1140, and an application layer 1155 on the OS kernel 1110.

The OS kernel 1110 is the core of an operating system. When the image display device is driven, the OS kernel 1110 may be responsible for operation of at least one of control of hardware drivers, security protection for hardware and processors in the image display device, efficient management of system resources, memory management, hardware interfacing by hardware abstraction, multi-processing, or scheduling associated with multi-processing. Meanwhile, the OS kernel 1110 may further perform power management.

The hardware drivers of the OS kernel 1110 may include, for example, at least one of a display driver, a Wi-Fi driver, a Bluetooth driver, a USB driver, an audio driver, a power manager, a binder driver, or a memory driver.

Alternatively or additionally, the hardware drivers of the OS kernel 1110 may be drivers for hardware devices within the OS kernel 1110. The hardware drivers may include a character device driver, a block device driver, and a network device driver. The block device driver may require a buffer for buffering data on a block basis, because data is transmitted on a block basis. The character device driver may not need a buffer since data is transmitted on a basic data unit basis, that is, on a character basis.

The OS kernel 1110 may be implemented based on any of various OSs such as Unix (Linux), Windows, etc. The OS kernel 1110 may be a general-purpose open-source kernel which can be implemented in other electronic devices.

The driver 1120 is interposed between the OS kernel 1110 and the middleware 1130. Along with the middleware 1130, the driver 1120 drives devices for operation of the application layer 1150. For example, the driver 1120 may include a driver(s) for a microcomputer, a display module, a Graphics Processing Unit (GPU), an FRC, a General-Purpose Input/Output (GPIO) pin, a High-Definition Multimedia Interface (HDMI), a System Decoder (SDEC) or DEMUX, a Video Decoder (VDEC), an Audio Decoder (ADEC), a Personal Video Recorder (PVR), and/or an Inter-Integrated Circuit (I2C). These drivers operate in conjunction with the hardware drivers of the OS kernel 1110.

In addition, the driver 1120 may include a driver for the remote controller, especially a pointing device to be described below. The remote controller driver may reside in the OS kernel 1110 or the middleware 1130, instead of the driver 1120.

The middleware 1130 resides between the OS kernel 1110 and the application layer 1150. The middleware 1130 may mediate between different hardware devices or different software programs, for data transmission and reception between the hardware devices or the software programs. Therefore, the middleware 1130 can provide standard interfaces, support various environments, and enable interaction between tasks conforming to heterogeneous communication protocols.

Examples of the middleware 1130 in the legacy system platform 1100 may include Multimedia and Hypermedia information coding Experts Group (MHEG) and Advanced Common Application Platform (ACAP) as data broadcasting-related middleware, PSIP or SI middleware as broadcasting information-related middleware, and DLNA middleware as peripheral device communication-related middleware.

The application layer 1150 that runs atop the middleware 1130 in the legacy system platform 1100 may include, for example, UI applications associated with various menus in the image display device. The application layer 1150 on top of the middleware 1130 may allow editing and updating over a network by user selection. Through the application layer 1150, the user may navigate a desired menu by manipulating the remote controller while viewing a broadcast program.

The application layer 1150 in the legacy system platform 1100 may further include at least one of a TV guide application, a Bluetooth application, a reservation application, a Digital Video Recorder (DVR) application, and a hotkey application.

In the smart system platform 1105, the library 1135 is positioned between the OS kernel 1110 and the framework 1140, forming the basis of the framework 1140. For example, the library 1135 may include Secure Socket Layer (SSL) (a security-related library), WebKit (a Web engine-related library), c library (libc), and Media Framework (a media-related library) specifying, for example, a video format and an audio format. The library 1135 may be written in C or C++. Also, the library 1135 may be exposed to a developer through the framework 1140.

The library 1135 may include a runtime 1137 with a core Java library and a Virtual Machine (VM). The runtime 1137 and the library 1135 form the basis of the framework 1140.

The VM may be a virtual machine that enables concurrent execution of a plurality of instances, that is, multi-tasking. For each application of the application layer 1155, a VM may be allocated and executed. For scheduling or interconnection between the plurality of instances, the binder driver (not shown) of the OS kernel 1110 may operate. The binder driver and the runtime 1137 may connect Java applications to C-based libraries.

The library 1135 and the runtime 1137 may correspond to the middleware 1130 of the legacy system platform.

In the smart system platform 1105, the framework 1140 includes programs on which applications of the application layer 1155 are based. The framework 1140 is compatible with any application and may allow component reuse, movement or exchange. The framework 1140 may include supporting programs and programs for interconnecting different software components. For example, the framework 1140 may include an activity manager related to activities of applications, a notification manager, and a CP for abstracting common information between applications. This framework 1140 may be written in Java.

The application layer 1155 on top of the framework 1140 includes a variety of programs that can be executed and displayed in the image display device. The application layer 1155 may include, for example, a core application that is a suite providing at least one of e-mail, Short Message Service (SMS), calendar, map, or browser functions. The application layer 1155 may be written in Java.

In the application layer 1155, applications may be categorized into user-undeletable applications 1165 stored in the image display device or user-deletable applications 1175 that are downloaded from an external device or a network and stored in the image display device.

Using the applications of the application layer 1155, a variety of functions such as an Internet telephony service, VoD service, Web album service, Social Networking Service (SNS), Location-Based Service (LBS), map service, Web browsing service, and application search service may be performed through network access. In addition, other functions such as gaming and schedule management may be performed by the applications.

Referring to FIG. 12, a platform for any of the image display devices according to the embodiments of the present invention is of an integrated type. The integrated-type platform may include an OS kernel 1210, a driver 1220, middleware 1230, a framework 1240, and an application layer 1250.

The integrated-type platform shown in FIG. 11 is different from the separate-type platform shown in FIG. 11 in that the library 1135 shown in FIG. 11 is deleted and the application layer 1250 is included as an integrated layer. The driver 1220 and the framework 1240 correspond to the driver 1120 and the framework 1140 of FIG. 11, respectively.

The library 1135 of FIG. 11 may be incorporated into the middleware 1230 of FIG. 12. That is, the middleware 1230 may include both the legacy system middleware and the image display system middleware. As described before, the legacy system middleware includes MHEG or ACAP as data broadcasting-related middleware, PSIP or SI middleware as broadcasting information-related middleware, and DLNA middleware as peripheral device communication-related middleware, and the image display system middleware includes SSL as a security-related library, WebKit as a Web engine-related library, libc, and Media Framework as a media-related library. The middleware 1230 may further include the above-described runtime.

The application layer 1250 may include a menu-related application, a TV guide application, a reservation application, etc. as legacy system applications, and e-mail, SMS, a calendar, a map, and a browser as image display system applications.

In the application layer 1250, applications may be categorized into user-undeletable applications 1265 that are stored in the image display device and user-installable or user-deletable applications 1275 that are downloaded from an external device or a network and stored in the image display device.

The platforms shown in FIGS. 11 and 12 may be general-purpose ones that can be implemented in many other electronic devices as well as in image display devices. The platforms of FIGS. 11 and 12 may be stored or loaded in the memory 640, the controller 670, or any other processor (not shown) or may be stored or load in the SI & metadata DB 711, the UI manager 714 or the service manager 713 shown in FIG. 5. To execute applications, an additional application processor (not shown) may be further provided.

The game application according to one embodiment is located in the application layer shown in FIG. 11 or 12. In particular, if the game application is installed in a process of producing a display device (e.g., TV), the display device is designed such that a user of the display device may not arbitrarily access or delete the game application.

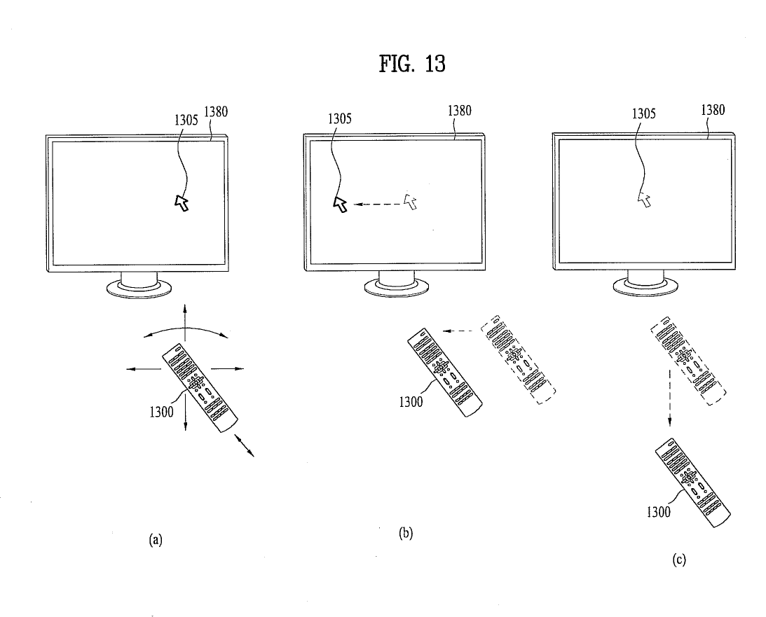

FIG. 13 illustrates a method for controlling any of the types of image display devices described herein using a remote controller. FIG. 13(a) illustrates a pointer 1305 representing movement of the remote controller 1300 displayed on the display 1380.

The user may move or rotate the remote controller 1300 up and down, side to side (FIG. 13(b)), and back and forth (FIG. 13(c)). The pointer 1305 displayed on the display 1380 of the image display device moves according to the movement of the remote controller 1300. Since the pointer 1305 moves in accordance with the movement of the remote controller 1300 in a 3D space as shown in FIG. 13, the remote controller 1300 may be referred to as a pointing device.

Referring to FIG. 13(b), if the user moves the remote controller 1300 to the left, the pointer 1305 moves to the left on the display 1380. A sensor of the remote controller 1300 detects movement of the remote controller 1300 and transmits motion information of the remote controller 1300 to the image display device. Then, the image display device calculates the coordinates of the pointer 1305 from the motion information of the remote controller 1300. The image display device then displays the pointer 1305 at the calculated coordinates.

Referring to FIG. 13(c), while pressing a predetermined button of the remote controller 1300, the user moves the remote controller 1300 away from the display 1380. Then, a selected area corresponding to the pointer 1305 may be zoomed in on and enlarged on the display 1380. On the contrary, if the user moves the remote controller 1300 toward the display 180, the selected area corresponding to the pointer 1305 is zoomed out and thus contracted on the display 1380. On the contrary, when the remote controller 1300 moves away from the display 1380, the selected area may be zoomed out and when the remote controller 1300 approaches the display 180, the selected area may be zoomed in.

With the predetermined button of the remote controller 1300 pressed, the up, down, left and right movements of the remote controller 1300 may be ignored. That is, when the remote controller 1300 moves away from or approaches the display 1380, only the back and forth movements of the remote controller 1300 are sensed, while the up, down, left and right movements of the remote controller 1300 are ignored. Unless the predetermined button is pressed in the remote controller 1300, the pointer 1305 moves in accordance with the up, down, left or right movement of the remote controller 1300.

The movement speed and direction of the pointer 1305 may correspond to the movement speed and direction of the remote controller 1300.

The pointer may be an object displayed on the display 1380 in correspondence with the movement of the remote controller 1300. Therefore, the pointer 1305 may have various shapes other than the arrow illustrated in FIG. 13. For example, the pointer 1305 may be a dot, a cursor, a prompt, a thick outline, etc. The pointer 1305 may be displayed across a plurality of points, such as a line and a surface, as well as at a single point on horizontal and vertical axes.

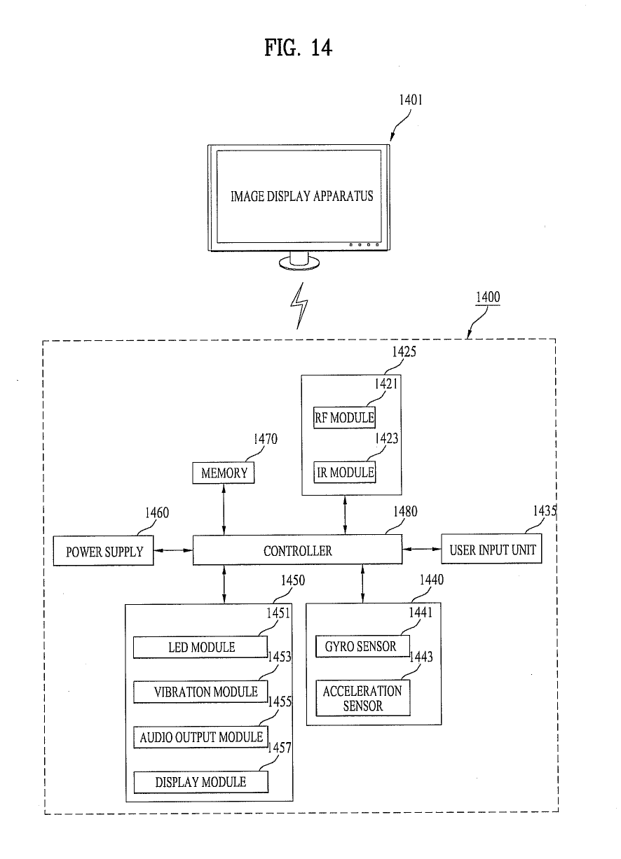

FIG. 14 is a detailed block diagram of the remote controller for use in controlling any of the types of image display devices described herein. Referring to FIG. 14, the remote controller 1400 may include a wireless communication module 1425, a user input unit 1435, a sensor unit 1440, an output unit 1450, a power supply 1460, a memory 1470, and a controller 1480.

The wireless communication module 1425 transmits signals to and/or receives signals from the image display device, e.g., image display device 1401.

The remote controller 1400 may include an RF module 1421 for transmitting RF signals to and/or receiving RF signals from the image display device 1401 according to an RF communication standard. The remote controller 1400 may also include an IR module 1423 for transmitting IR signals to and/or receiving IR signals from the image display device 1401 according to an IR communication standard.

In one embodiment, remote controller 1400 transmits motion information representing movement of the remote controller 1400 to the image display device 1401 through the RF module 221. The remote controller 1400 may also receive signals from the image display device 1401 through the RF module 1421. As needed, the remote controller 1400 may transmit commands such as a power on/off command, a channel switch command, or a volume change command to the image display device 1401 through the IR module 1423.

The user input unit 1435 may include a keypad, a plurality of buttons, a touchpad and/or a touch screen. The user may enter commands associated with the image display device 1401 to the remote controller 1400 by manipulating the user input unit 1435. If the user input unit 1435 includes a plurality of hard buttons, the user may input various commands associated with the image display device 1401 to the remote controller 1400 by pressing the hard buttons.

Alternatively or additionally, if the user input unit 1435 includes a touchscreen displaying a plurality of soft keys, the user may input various commands associated with the image display device 1401 to the remote controller 1400 by touching the soft keys. The user input unit 1435 may also include various input tools other than those set forth herein, such as a scroll key and/or a jog wheel, which should not be construed as limiting the present invention.

The sensor unit 1440 may include a gyro sensor 241 and/or an acceleration sensor 1443.

The gyro sensor 1441 may sense movement of the remote controller 1400.

For example, the gyro sensor 1441 may sense movement of the remote controller 1400 in X, Y, and Z-axis directions. The acceleration sensor 1443 may sense the speed of the remote controller 1400. The sensor unit 1440 may further include a distance sensor for sensing the distance between the remote controller 1400 and the display device 1401.

The output unit 1450 may output a video and/or audio signal corresponding to manipulation of the user input unit 1435 or corresponding to a signal received from the image display device 1401. The user may easily identify whether the user input unit 1435 has been manipulated or whether the image display device 1401 has been controlled, based on the video and/or audio signal output by the output unit 1450.

The output unit 1450 may include a Light Emitting Diode (LED) module 1451 which is turned on or off whenever the user input unit 1435 is manipulated or whenever a signal is received from or transmitted to the image display device 1401 through the wireless communication module 1425, a vibration module 1453 which generates vibrations, an audio output module 1455 which outputs audio data, and/or a display module 1457 which outputs video data.

The power supply 1460 supplies power to the remote controller 1400. If the remote controller 1400 remains stationary for a predetermined time or longer, the power supply 1460 may, for example, reduce or shut off supply of power to the spatial remote controller 1400 in order to save power. The power supply 1460 may resume power supply if a predetermined key of the remote controller 1400 is manipulated.

The memory 1470 may store various types of programs and application data necessary to control or drive the remote controller 1400. The remote controller 1400 may wirelessly transmit signals to and/or receive signals from the image display device 1401 over a predetermined frequency band with the aid of the RF module 1421. The controller 1480 of the remote controller 1400 may store information regarding the frequency band used for the remote controller 1400 to wirelessly transmit signals to and/or wirelessly receive signals from the paired image display device 1401 in the memory 1470, for later use.

The controller 1480 provides overall control to the remote controller 1400. The controller 1480 may transmit a signal corresponding to a key manipulation detected from the user input unit 1435 or a signal corresponding to motion of the remote controller 1400, as sensed by the sensor unit 1440, to the image display device 1401.

In one embodiment, the remote controller 1400 may correspond to a user terminal necessary to execute a game application. Accordingly, in association with gaming by the game application of the present invention, a signal input through the user input unit 1435 of the remote controller 1400 is analyzed by the controller 1480 and is transmitted to the image display device through the wireless communication module 1425, thereby being applied to the played game. That is, the game may be played by controlling a card or a pointer displayed on the image display device.

In one embodiment, the remote controller may determine a distance between the image display device and the remote controller using the wireless communication module 1425 or the distance sensor (not shown). If the remote controller moves away from the image display device, a game main screen displayed on the image display device is enlarged and, if the remote controller approaches the image display device, the game main screen is reduced. Enlargement and reduction may be inversely controlled according to user setting.

In another embodiment, enlargement and reduction may be performed only when the distance between the remote controller and the image display apparatus is changed in a state in which a predetermined button of the remote controller 1400 is pressed.

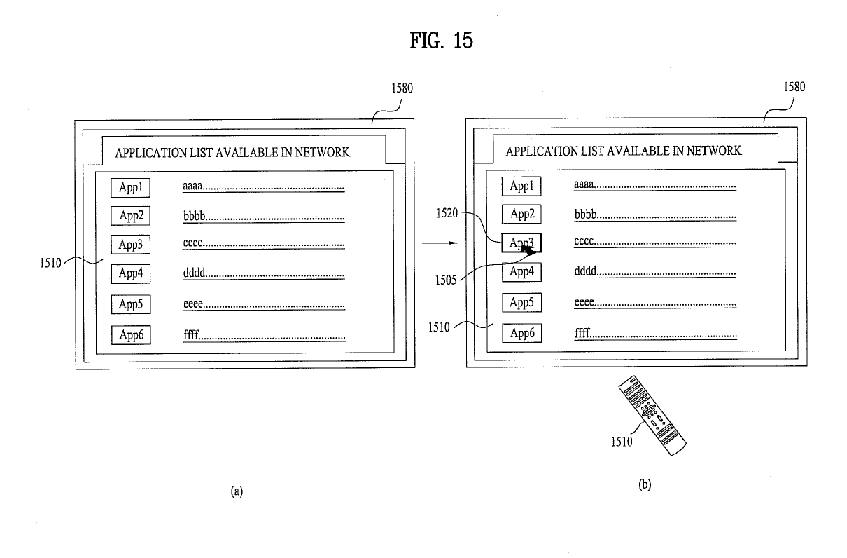

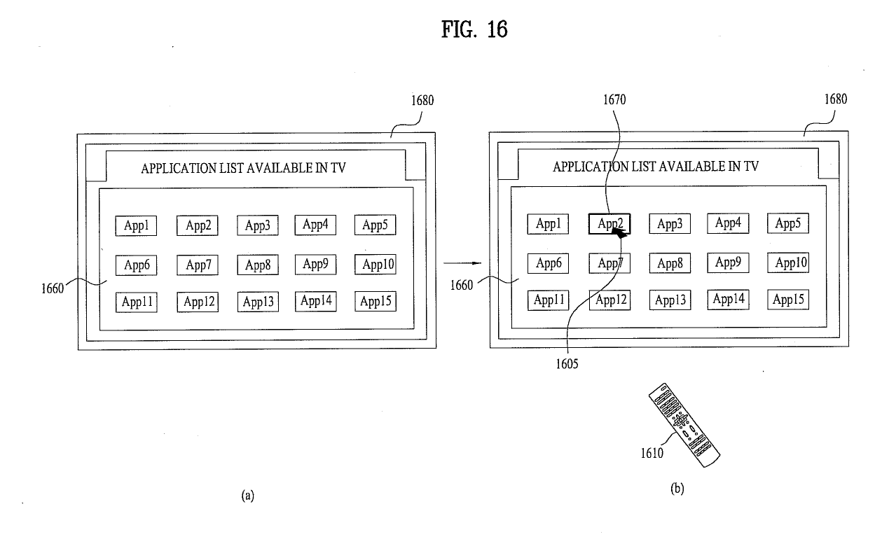

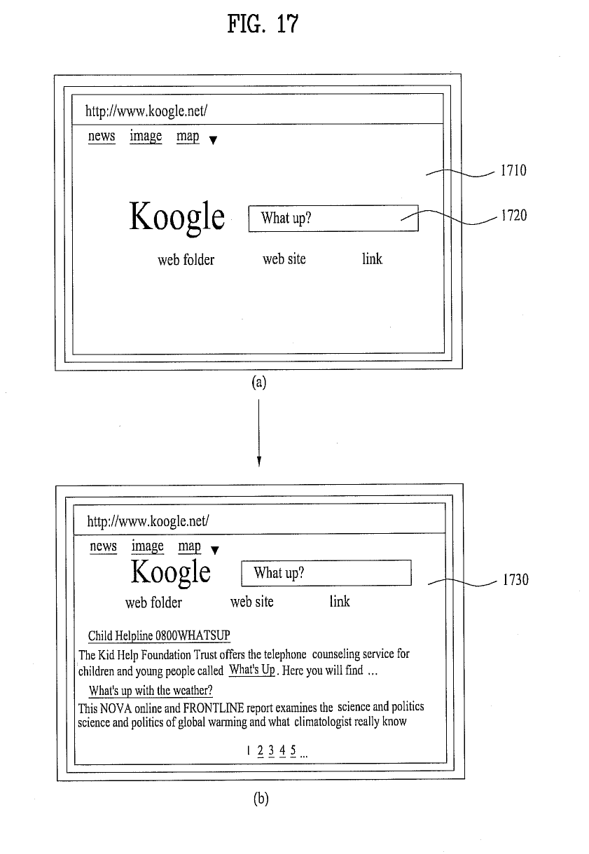

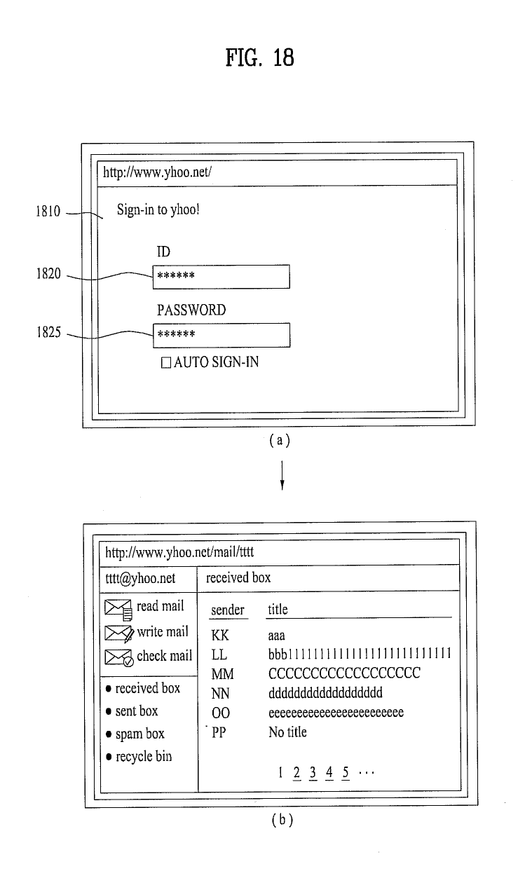

FIG. 15 is a diagram showing a first embodiment of a UI that may be used for any of the types of image display devices described herein, FIG. 16 is a diagram showing a second embodiment of such a UI, FIG. 17 is a diagram showing a third embodiment of such a UI, and FIG. 18 is a diagram showing a fourth embodiment of such a UI.

Referring to FIG. 15, an application list received over a network is displayed on the display 1580. A user may directly access a CP or an NP, search for various applications, and download the applications from the CP or the NP.

Specifically, FIG. 15(a) illustrates an application list 1510 available in a connected server, displayed on the display 180. The application list 1510 may include an icon representing each application and a brief description of the application. Because one or more of the image display devices described herein are capable of full browsing, it may enlarge the icons or descriptions of applications received from the connected server on the display 1580. Accordingly, the user can readily identify applications.

FIG. 15(b) illustrates selection of one application 1520 from the application list 1510 using the pointer 1505 of the remote controller 1510. Thus, the selected application 1520 may be easily downloaded.

In one embodiment, a game application may be included in the application list 1510. The game application included in the application list 1510 may include a game application for performing a game play process and providing a display screen to the image display device and a game application for performing a user control function necessary to play a game. Accordingly, a user may select a game application from the application list 1510 and download the game application to the image display device or the user terminal.

FIG. 16 illustrates an application list of the image display device, displayed on the display 1680. Referring to FIG. 16(a), when the user selects an application list view menu by manipulating the remote controller 1610, a list of applications 1660 stored in the image display device is displayed on the display 1680. While only icons representing the applications are shown in FIG. 16, the application list 1660 may further include brief descriptions of the applications, like the application list illustrated in FIG. 15. Therefore, the user can readily identify the applications.

FIG. 16(b) illustrates selection of one application 1670 from the application list 1660 using the pointer 1205 of the remote controller 1610. Thus, the selected application 1670 may be easily executed.

While it is shown in FIG. 16 that the user selects a desired item by moving the pointer 1605 using the remote controller 1610, the application may be selected in many other ways. For example, the user may select a specific item using a cursor displayed on the screen by combined input of an OK key and a direction key of a local key (not shown) or the remote controller 1610.

In another example, if the remote controller has a touch pad, the pointer 1605 moves on the display 1680 according to touch input of the touch pad. Thus the user may select a specific item using the touch-based pointer 1605.

FIG. 17 illustrates a Web page displayed on the display of the image display device. Specifically, FIG. 17(a) illustrates a Web page 1710 with a search window 1720, displayed on the display. The user may enter a character into the search window 1720 by use of character keys (not shown) of a keypad displayed on a screen, character keys (not shown) of local keys, or character keys (not shown) of the remote controller.

FIG. 17(b) illustrates a search result page 1730 having search results matching a keyword entered into the search window, displayed on the display. Since one or more of the image display devices described herein are capable of fully browsing a Web page, the user can easily read the Web page.

FIG. 18 illustrates another Web page displayed on the display. Specifically, FIG. 18(a) illustrates a mail service page 1810 including an ID input window 1820 and a password input window 1825, displayed on the display. The user may enter a specific numeral and/or text into the ID input window 1820 and the password input window 1825 using a keypad (not shown) displayed on the mail service page, character keys (not shown) of local keys, or character keys (not shown) of the remote controller. Hence, the user can log in to a mail service.

FIG. 18(b) illustrates a mail page displayed on the display, after a user logs in to the mail service. For example, the mail page may contains items “read mail”, “write mail”, “sent box”, “received box”, “recycle bin”, etc. In the “received box” item, mail may be ordered by sender or by title. One or more of the image display devices are capable of full browsing when displaying a mail service page. Therefore, the user can conveniently use the mail service.

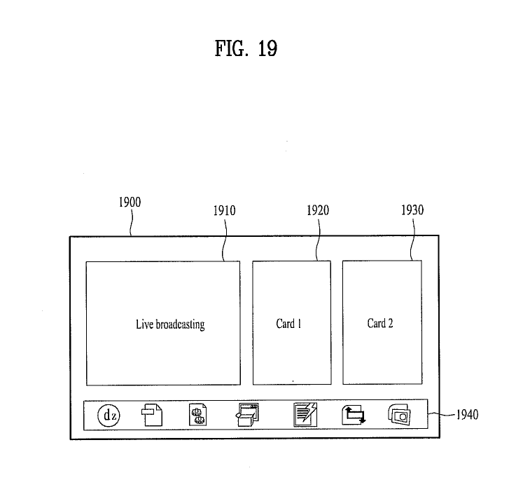

FIG. 19 illustrates an example of a Main Home screen of a network TV according to one embodiment. Other types of home screens may be used in other embodiments. However, hereinafter and for illustrative purposes only, the Main Home screen of the network TV shown in FIG. 19 will be discussed.

As shown in FIG. 19, a network TV 1900 according to one embodiment may display a Live Broadcast Program area 1910, wherein a live program is currently being broadcasted, application-related Card areas 1920 and 1930, and a Downloaded Applications area 1940 on the Main Home screen. The user may use an interface, such as a remote controller, so as to execute a specific application among multiple applications that are displayed on the Downloaded Applications area 1940.

A number of downloadable applications may increase exponentially depending upon the performance of a memory, CPU, and so on, of the network TV 1900. In this case, the user may experience some difficulty in intuitively selecting a specific application. Solution for resolving these and other problems will be described in detail with reference to the accompanying drawings.

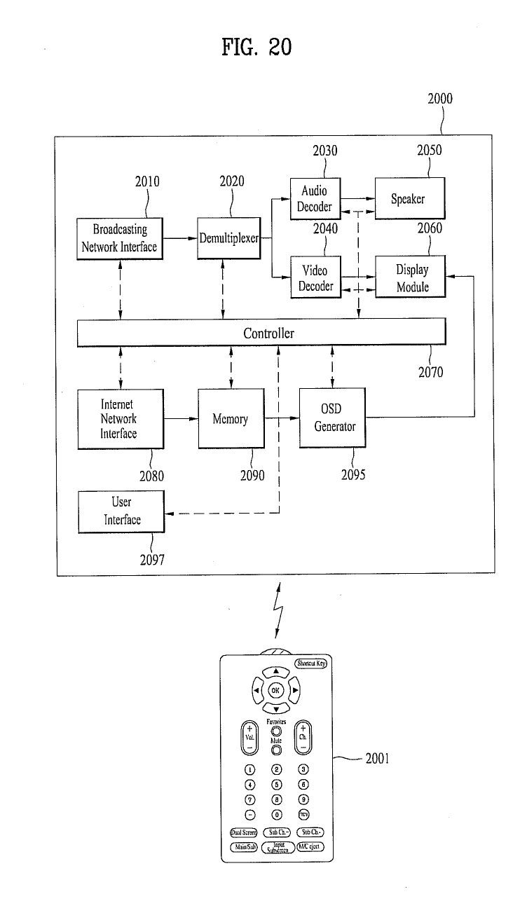

FIG. 20 shows an example of modules that may be used for or included in a network TV according to one embodiment. In other embodiments, different modules may be used. Also, those modules can be configured in the form of hardware or software, or a combination of hardware and software.

As shown in the example of FIG. 20, the network TV 2000 processing multiple applications according to the one embodiment includes a broadcast network interface 2010, a demultiplexer (DEMUX) 2020, an audio decoder 2030, a video decoder 2040, a speaker 2050, a display module 2060, a controller 2070, an internet network interface 2080, a memory 2090, an on-screen display (OSD) generator 2095, and a user interface 2097.

More specifically, the broadcast network interface 2010 receives broadcast data including audio data and video data. And, the demultiplexer (DEMUX) 2020 demultiplexes the audio data and video data included in the received broadcast data. Thereafter, the audio decoder 2030 decodes the demultiplexed audio data, and the speaker 2050 outputs the decoded audio data. Furthermore, the video decoder 2040 decodes the demultiplexed video data, and the display module 2060 outputs the decoded video data.

Meanwhile, the internet network interface 2080 receives at least one or more applications, and the memory 2090 downloaded the received applications. Additionally, when a first input signal is received through the user interface 2097, the OSD generator 2095 generates at least one or more display areas corresponding to an assigned number of each downloaded application.

Also, the display module 2060 displays image data indicating a specific application and a unique number corresponding to the specific application in each of the generated display areas. Furthermore, when a second input signal, which is configured for selecting the unique number, is received through the user interface 2097, the controller 2070 controls the network TV so that the specific application can be executed. The user interface 2097 of the network TV 2000 may be equipped with number key buttons.

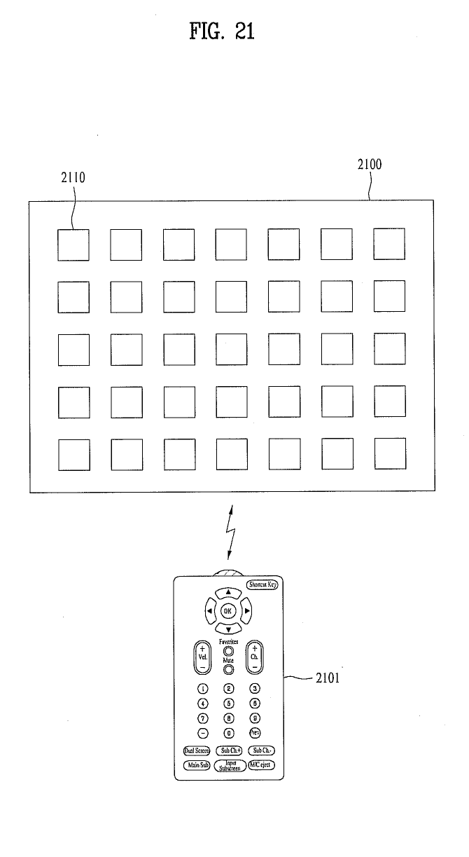

Alternatively, according to another one embodiment, the user interface 2097 of the network TV 2000 may be designed to receive a command signal respective to a specific number key by communicating with a remote controller 2001. A method enabling the network TV 2000 shown in FIG. 20 to intuitively display several tens of downloaded applications will be described later on in more detail with reference to FIG. 21 to FIG. 24.

Meanwhile, according to one or another embodiment, when a third input signal configured to indicate a Favorite Applications group is received through the user interface 2097 or the remote controller 2001, among the downloaded applications, the controller 2070 collects a plurality of predetermined favorite applications. Furthermore, the display module 2060 may be designed to differentiate the collected favorite applications group from a non-favorite applications group and to display the collected favorite applications group accordingly.

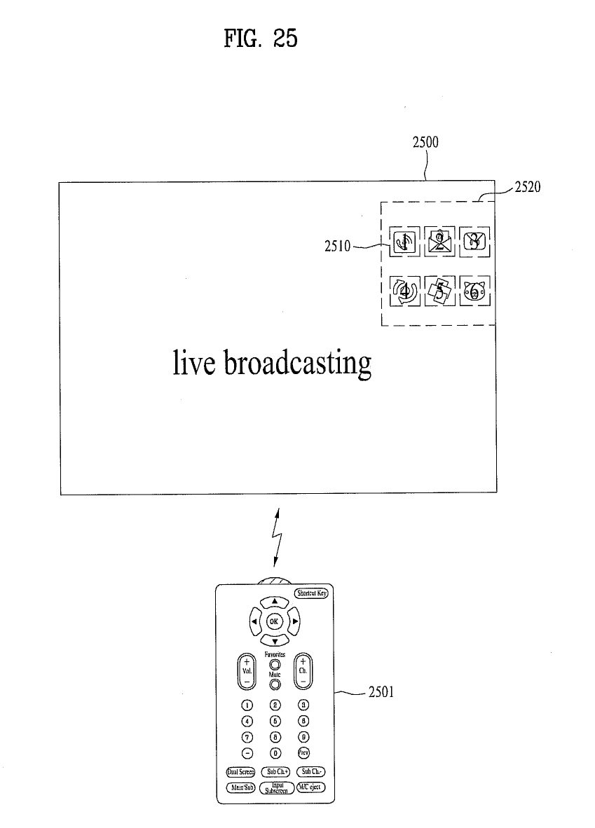

The display method of the display module 2060 may be divided into two different types. In the first display, the display module 2060 consecutively displays display areas of the collected at least one or more favorite applications and, then, consecutively displays display areas of the at least one or more non-favorite applications. Alternatively, in the second display method, the display module 2060 may display the display area of the collected favorite applications as a selectable area, and the display module 2060 may display the display area of the non-favorite applications as a non-selectable area. The display methods will be described later on in more detail with reference to FIG. 25 to FIG. 27.

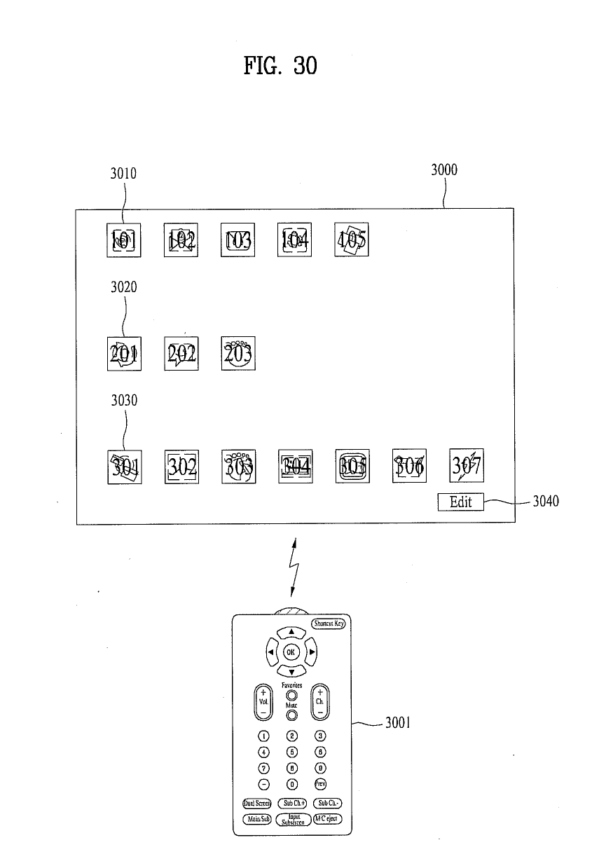

According to another one embodiment, when a fourth input signal configured to indicate an applications group for each category is received through the user interface 2097 or the remote controller 2001, the controller 2070 uses category information of the downloaded applications so as to collect applications by each category. Thereafter, the display module 2060 consecutively displays display areas of at least one or more applications belonging to a first category, and the display module 2060 also consecutively displays display areas of at least one or more applications belonging to a second category. The display method will be described later on in more detail with reference to FIG. 30.

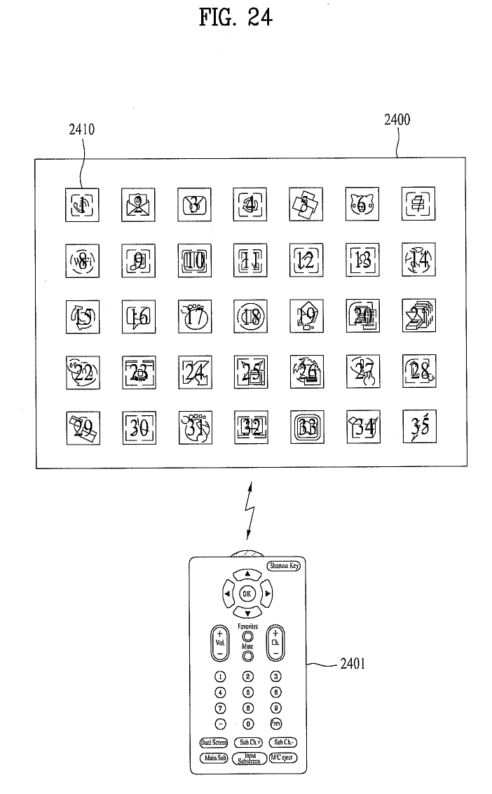

FIG. 21 to FIG. 23 respectively illustrate process steps for categorizing downloaded applications and displaying the categorized applications in the network TV according to one embodiment. And, FIG. 24 illustrates a first display screen displaying downloaded applications in the network TV according to the one embodiment. Hereinafter, a solution for generating a user interface (UI) for easily selecting applications downloaded by the network TV will be described in detail with reference to FIG. 21 to FIG. 23, and the displayed UI will be described with reference to FIG. 24.

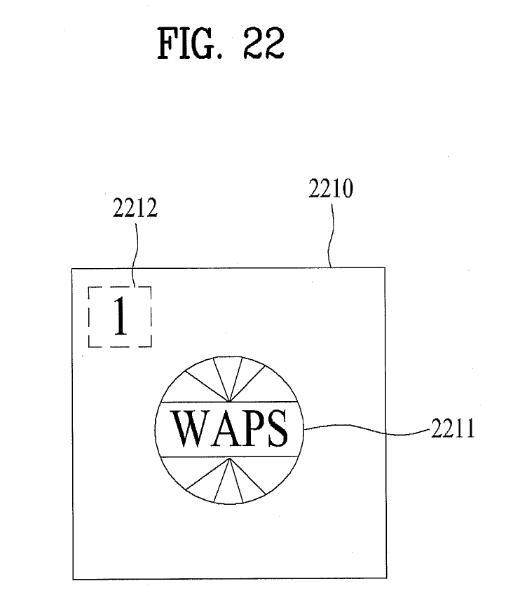

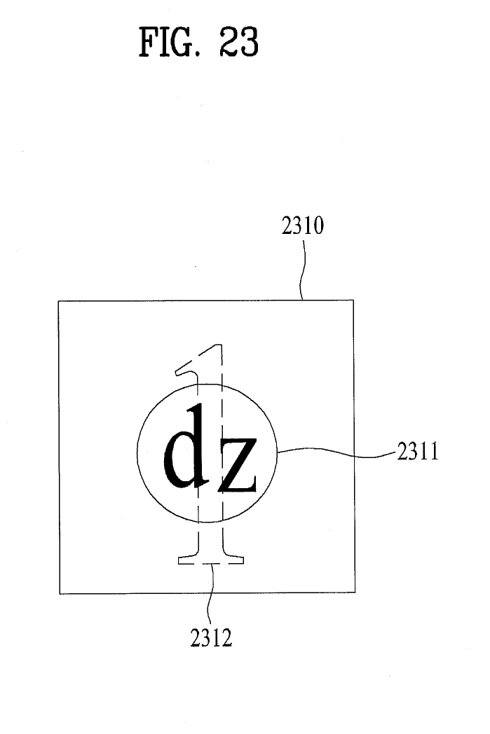

As shown in FIG. 21, the network TV according to one embodiment may generates a display area 2110, which is split (or divided) in accordance with the number of downloaded applications. Although it is assumed in the example shown in FIG. 21 that the number of downloaded applications is equal to 35, the present invention will not be limited to the example given herein. Meanwhile, the remote controller 2101 shown in FIG. 21 is designed to control the network TV 2100 and to transmit a command respective to a combination of multiple numbers. The display area 2110 shown in FIG. 21 will be described in more detail with reference to FIG. 22 and FIG. 23.

An expanded view of the display area 2110 shown in FIG. 21 corresponds to a display area 2210 shown in FIG. 22. The network TV according to one embodiment adjusts (or controls) a position of image data 2211 of an application that is to be displayed and a position of a unique number 2212 respective to the corresponding application within the display area 2210 corresponding to each application. As shown in FIG. 22, x and y coordinates of the display area 2210 are used to calculate the positions of the image data 2211 and the unique number 2212, so that the image data 2211 and the unique number 2212 to not overlap.

Alternatively, an expanded view of the display area 2110 shown in FIG. 21 corresponds to a display area 2310 shown in FIG. 23. The network TV according to one embodiment adjusts (or controls) a position of image data 2311 of an application that is to be displayed and a position of a unique number 2312 respective to the corresponding application within the display area 2310 corresponding to each application. As shown in FIG. 23, the image data 2311 may overlap with the unique number 2312. However, in this case, in order to ensure the user's visibility, the network TV may be designed so that one of the image data 2311 and the unique number 2312 can be semi-transparent.

When it is assumed that the network TV is designed as described in FIG. 21 to FIG. 23, after pushing a shortcut key or Hot Key from the remote controller 2401, as shown in FIG. 24, network TV 2400 displays image data as well as a unique number of the corresponding application in the divided (or split) display area 2410. Accordingly, by using a conventional remote controller, and by simply selecting a unique number corresponding to a specific application, the selected specific application may be immediately executed. Most particularly, if the network TV is capable of downloading several tens or hundreds of application, the UI shown in FIG. 24 may increase an application access speed to a higher rate.

FIG. 25 illustrates a second display screen displaying downloaded applications in the network TV according to one embodiment. Hereinafter, a first method for displaying favorite applications among the downloaded applications in the network TV according to the one embodiment will be described in detail with reference to FIG. 25.

As shown in FIG. 25, while outputting a live broadcast program, when the network TV 2500 according to the one embodiment receives a command signal respective to a favorite key, a pop-up window 2520 including a divided display area 2510 of favorite applications. Meanwhile, for example, the favorite key may correspond to a shortcut key or a hot key already existing in the remote controller 2501. Alternatively, the favorite key may also be designed as a separate key within the remote controller.

The divided display area of favorite applications within the pop-up window 2520 may be realized according to two embodiments of the present invention. According to a first embodiment, the divided display region 2510 of a specific favorite application may be selected by using direction key buttons of the remote controller 2501. Alternatively, as shown in FIG. 25, according to a second one embodiment, the divided display region 2510 of the favorite application may be designed to include a unique number and to be outputted.

Accordingly, by simply selecting a unique number respective to the divided display area 2510 of the favorite application shown in FIG. 25, the user may easily access the wanted favorite application. Meanwhile, the unique number may correspond to a number predetermined by the user, or the unique number may correspond to a number automatically generated based upon a downloaded order of the downloaded application.

Additionally, the above-described first embodiment and the second embodiment may be selected in accordance with the user's choice or may be automatically selected. More specifically, the above-described first embodiment may be more advantageous when used in a case where the number of favorite applications is smaller. And, the second embodiment may be more advantageous when used in a case where the number of favorite applications is larger.

For example, when a number of favorite applications downloaded in the network TV is smaller than or equal to a number of direction key buttons of the remote controller, the network TV is designed to display a divided display area according to the first embodiment. Alternatively, when a number of favorite applications downloaded in the network TV is greater than or equal to a number of direction key buttons of the remote controller, the network TV is designed to display a divided display area according to the second embodiment.

Furthermore, the favorite application may correspond to an application personally set-up by the user through a set-up menu, such as an Edit menu. Alternatively, the favorite application may also be automatically determined based upon a number of accesses or an access time of a specific application. Therefore, the user may immediately access a favorite application while viewing a live broadcast program.

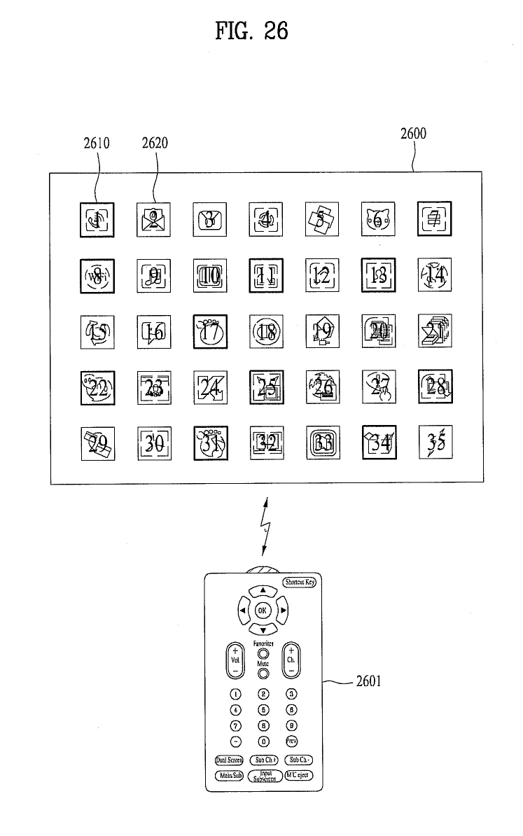

FIG. 26 illustrates a third display screen displaying downloaded applications in the network TV according to one embodiment. Hereinafter, a second method for displaying favorite applications among the downloaded applications in the network TV according to the one embodiment will be described in detail with reference to FIG. 26.

While a display area respective to the entire set of downloaded applications is being displayed, as shown in FIG. 24, and when the network TV 2600 receives a command signal respective to a Favorites key (herein, the Favorites key may be configured as a Shortcut key or a Hot key) of the remote controller shown in FIG. 26, the network TV 2600 outputs the display areas by differentiating a display area 2610 corresponding to favorite applications from a display area 2620 corresponding to non-favorite applications.

At this point, the user may be able to verify the favorite applications at one look, the favorite applications being more emphasized than the non-favorite applications. Thereafter, the user may select a unique number corresponding to a specific favorite application, thereby quickly executing the specific favorite application. Also, as shown in FIG. 26, the display area 2610 corresponding to favorite applications may be designed to be in a selectable activated state. And, the display area 2620 corresponding to non-favorite applications (i.e., other general applications) may be designed to be in a non-selectable inactivated state. If the display areas are designed as described above, only the favorite applications may be selected by using the direction arrow buttons provided in the remote controller 2601.

For example, referring to FIG. 26, the favorite applications are applications #1, #7, #8, #11, #13, #17, #22, #25, #28, #31, and #34. At this point, a cursor is first placed over the display area of application #1. Then, when the network TV 2600 received a command signal correspond to a rightward arrow button, the display area of application #7 is selected instead of the display area of application #2. This is because the display areas of applications #2 to #6, which correspond to the non-favorite applications, are in a non-selectable inactive state.

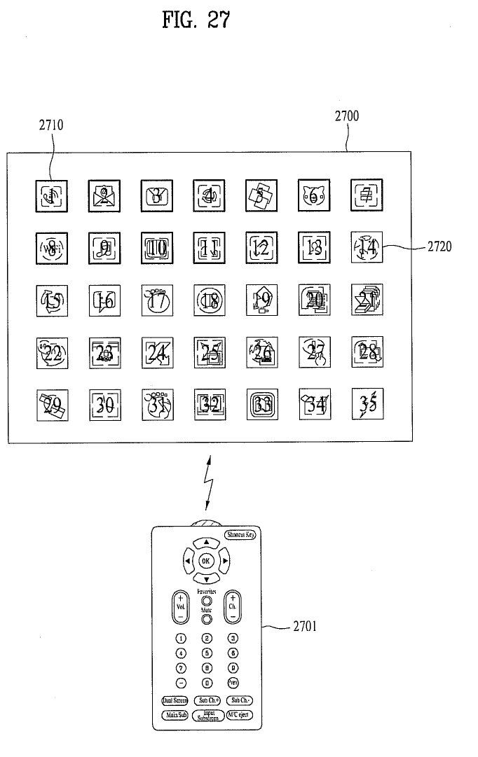

FIG. 27 illustrates a fourth display screen displaying downloaded applications in the network TV according to one embodiment. Hereinafter, a third method for displaying favorite applications among the downloaded applications in the network TV according to the one embodiment will be described in detail with reference to FIG. 27.

While a display area respective to the entire set of downloaded applications is being displayed, as shown in FIG. 24, and when the network TV 2700 receives a command signal respective to a Favorites key (herein, the Favorites key may be configured as a Shortcut key or a Hot key) of the remote controller shown in FIG. 27, the network TV 2700 outputs the display areas by differentiating a display area 2710 corresponding to favorite applications from a display area 2720 corresponding to non-favorite applications.

Unlike the method shown in FIG. 26, in the method of FIG. 27, the favorite applications are grouped and positioned with higher priority (i.e., in the upper positions), and the remaining non-favorite applications are all positioned with lower priority (i.e., in the lower positions). For example, smaller numbers (i.e., higher ranking numbers) are respectively assigned as the unique number for each of the favorite applications, and larger numbers (i.e., lower ranking numbers) are respectively assigned as the unique number for each of the non-favorite applications. However, in case the user personally sets up and edits the unique numbers, only the positions of the favorite applications are placed to precede the non-favorite applications, regardless of the rank of the unique numbers.

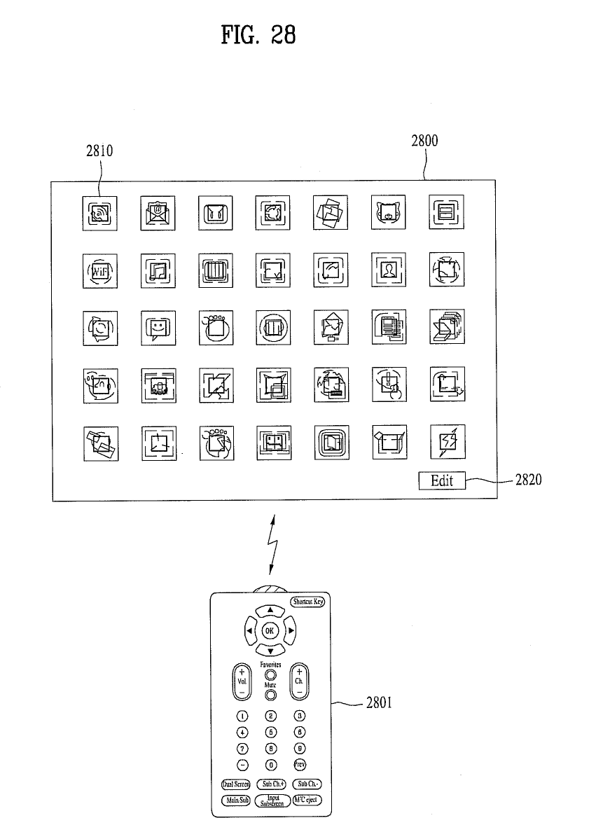

FIG. 28 illustrates a fifth display screen displaying downloaded applications in the network TV according to one embodiment. Hereinafter, a method of respectively assigning unique numbers to all of the applications downloaded by the network TV according to the one embodiment will now be described in detail with reference to FIG. 28.

As shown in FIG. 28, when the user uses the remote controller 2801 to control the network TV 2800 and to select an Edit icon 2820, all display areas 2810 corresponding to each of the currently downloaded applications may be changed to a state allowing the user to arbitrarily input the unique numbers. Accordingly, the user may conveniently reconfigure (or adjust) the unique numbers respective to each application based upon his (or her) own preference level or priority level. Evidently, as described in the method shown in FIG. 26, the unique numbers may be personally edited and set up by the user, or the unique numbers may be automatically decided based upon profile data of each application, the profile data corresponding to the downloaded time, number of accesses of each application.

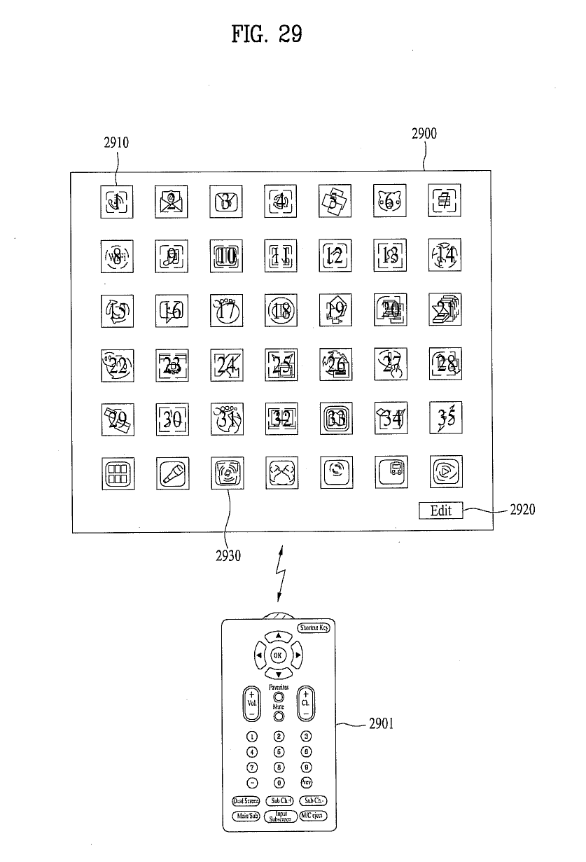

FIG. 29 illustrates a sixth display screen displaying downloaded applications in the network TV according to one embodiment. Hereinafter, a method for assigning unique applications to newly downloaded applications in the network TV according to the one embodiment will now be described in detail with reference to FIG. 29.

As shown in FIG. 29, when the user uses the remote controller 2901 to control the network TV 2900 and to select an Edit icon 2920, the network TV 2900 outputs the display areas by differentiating a display area 2910 corresponding to applications that are already respectively assigned with a unique number from a display area 2930 corresponding to newly downloaded applications that are not yet mapped to a unique number. Herein, only the display area 2930 corresponding to the newly downloaded applications may be changed to an editable state. Referring to FIG. 29, it is assumed that unique numbers have been assigned only to the 35 currently downloaded applications, and that unique numbers for seven newly downloaded applications, which are located in the last line of applications, are not yet assigned.

FIG. 30 illustrates a seventh display screen displaying downloaded applications in the network TV according to one embodiment. A method for aligning downloaded applications by the respective category and displaying the aligned applications will now be described in detail with reference to FIG. 30.

Referring to FIG. 30, when the network TV 3000 receives an input signal for indicating an applications group by each category through a remote controller 3001 or a user interface of the network TV 3000, the network TV 3000 uses category information (e.g., applications related to Games, applications related to News, applications related to Sports, applications related to Health, applications related to Convenient Lifestyles, and so on) of the already-downloaded applications, so as to collect the applications by the respective category.

As shown in FIG. 30, the network TV 3000 consecutively displays display areas 3010 of the applications related to Games, then consecutively displays display areas 3020 of the applications related to Convenient Lifestyles, and then consecutively displays display areas 3030 of the applications related to News.

Moreover, as shown in FIG. 30, to enable the user to easily recognize the applications belonging to the same category, the network TV 3000 according to the present invention is designed to respectively map consecutive unique numbers to the categorized applications. More specifically, #101, #102, #103, #104, and #105 are assigned to the applications related to Games, #201, #202, and #203 are assigned to the applications related to Convenient Lifestyle, and #301, #302, #303, #304, #305, #306, and #307 are assigned to applications related to News.

Meanwhile, although diverse methods of displaying applications are given as the examples in the appended drawings including FIG. 30, this is merely exemplary. And, therefore, the scope of the embodiments described herein is not to be limited only to the examples given herein.

For example, the present embodiments may also be applied to methods for displaying content, websites, Movies data, Music data, and so on. Accordingly, FIG. 30 shows an example of classifying the downloaded application by the respective category, all of the downloaded applications may be grouped and displayed as a single group, or all websites may be grouped and displayed as a single group, or all contents may be grouped by the respective website and displayed accordingly.

If the network TV is designed as described above or in accordance with other embodiments described herein, the user may be capable of verifying all of the data stored in the network TV by the respective groups. And, the user may quickly and easily access specific data by simply clicking on the respective unique number.

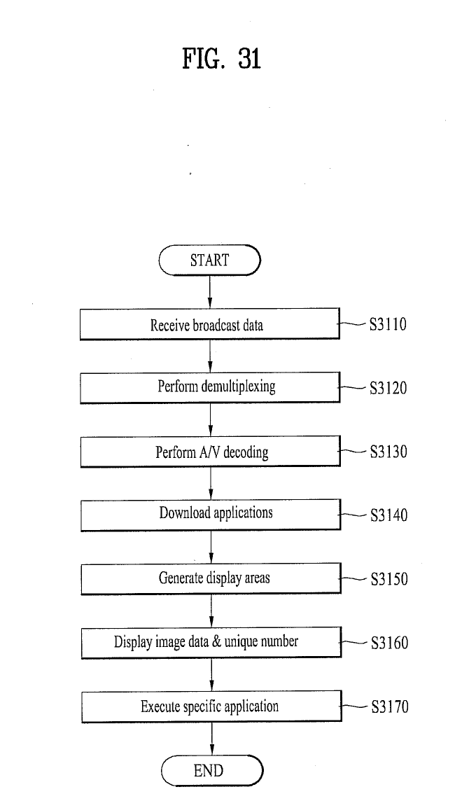

FIG. 31 illustrates a flow chart showing a method for controlling the network TV according to one embodiment. An overall method for controlling the network TV according to the one embodiment will be described in detail with reference to FIG. 31. However, it is to be understood that the method described herein is merely exemplary. Furthermore, the method in FIG. 31 may be supplementarily interpreted and understood based upon the description given with reference to FIG. 1 to FIG. 30.

The network TV processing multiple applications according to one embodiment receives broadcast data including audio data and video data through a broadcast network (S3110). Thereafter, the network TV demultiplexes the audio data and video data included in the received broadcast data (S3120) and, then, decodes the demultiplexed audio data and video data (S3130).

Subsequently, the network TV downloads at least one or more applications through an Internet network (S3140), and, when a first input signal is received, the network TV generates at least one or more display areas corresponding to an assigned number of each downloaded application (S3150).

Thereafter, the network TV displays image data indicating a specific application and a unique number corresponding to the specific application in each of the generated display areas (S3160). Then, when a second input signal, which is configured for selecting the unique number, is received, the network TV is controlled so that the specific application can be executed (S3170).

According to this or another embodiment, step S3160 may be designed to further include the steps of receiving a third input signal configured to indicate a Favorite Applications group, collecting a plurality of predetermined favorite applications among the downloaded applications, and differentiating the collected favorite applications group from a non-favorite applications group and displaying the differentiated applications groups accordingly.

Most particularly, the step of differentiating the collected favorite applications group from a non-favorite applications group and displaying the differentiated applications groups accordingly, may be designed to consecutively display the display areas of the collected at least one or more favorite applications and, then, to consecutively display the display areas of the at least one or more non-favorite applications (FIG. 27).

Alternatively, the step of differentiating the collected favorite applications group from a non-favorite applications group and displaying the differentiated applications groups accordingly, may also be designed to display the display areas of the collected favorite applications as selectable areas and to display the display areas of the non-favorite applications as non-selectable areas (FIG. 26).

According to yet another one embodiment, step S3160 may be designed to further include the steps of receiving a fourth input signal configured to indicate an applications group for each category, and using category information of the downloaded applications so as to collect applications by each category. Alternatively, step S3160 may be designed to further include the steps of consecutively displaying display areas of at least one or more applications belonging to a first category, and consecutively displaying display areas of at least one or more applications belonging to a second category.

In accordance with another embodiment, a recording medium readable by a computer may be provided to store a program to be executed by a computer, processor, or other type of device for entirely or partially executing the method shown in FIG. 31 as well as the other methods described herein.

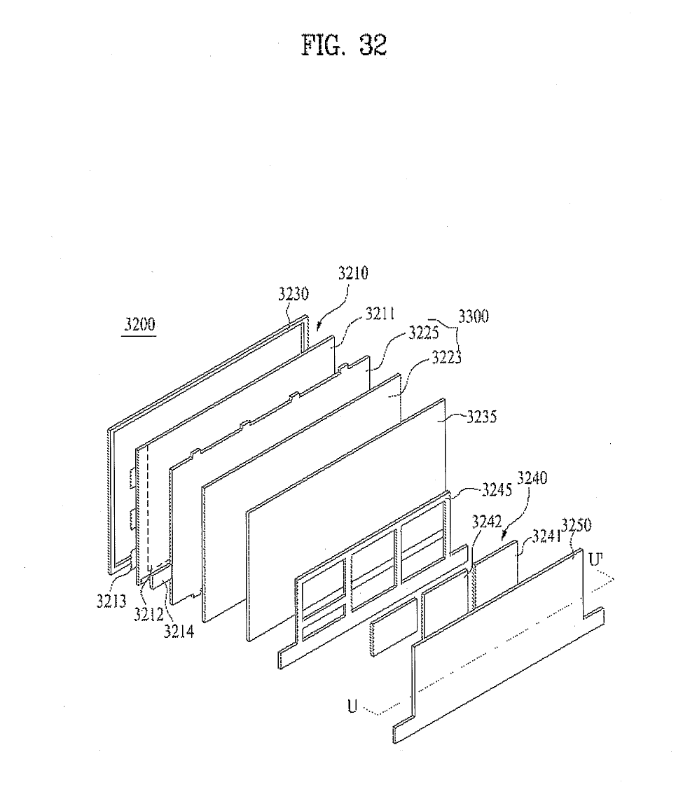

FIG. 32 illustrates a display device according to an exemplary embodiment of the invention. As shown in FIG. 32, a display device 3200 according to an exemplary embodiment of the invention may include a display panel 3210, a backlight unit 3300, a cover 3230, a bottom plate 3235, a driver 3240, and a back case 3250. For example, a display device according to the present invention may use LED or OLED. Detail descriptions on the display device using the LED or OLED as follows.

The display panel 3210 is an image displaying element and may include a first substrate 3211 and a second substrate 3212 that are positioned opposite each other and are attached to each other with a liquid crystal layer interposed therebetween. Although it is not shown, a plurality of scan lines and a plurality of data lines may cross each other in a matrix form on the first substrate 3211 called a thin film transistor (TFT) array substrate, thereby defining a plurality of pixels. Each pixel may include a thin film transistor capable of switching on and off a signal and a pixel electrode connected to the thin film transistor.

Red (R), green (G), and blue (B) color filters corresponding to each pixel and black matrixes may be positioned on the second substrate 3212 called a color filter substrate. The black matrixes may surround the R, G, and B color filters and may cover a non-display element such as the scan lines, the data line, and the thin film transistors. A transparent common electrode covering the R, G, and B color filters and the black matrixes may be positioned on the second substrate 3212.

A printed circuit board (PCB) may be connected to at least one side of the display panel 3210 through a connection member such as a flexible circuit board and a tape carrier package (TCP), and the display panel 3210 may be closely attached to a back surface of the bottom plate 3235 in a module process.

When the thin film transistors selected by each scan line are switched on in response to an on/off signal that is transferred from a gate driving circuit 3213 through the scan lines, a data voltage of a data driving circuit 3214 is transferred to the corresponding pixel electrode through the data lines and an arrangement direction of liquid crystal molecules changes by an electric field between the pixel electrode and the common electrode. Hence, the display panel 3210 having the above-described structure displays an image by adjusting a transmittance difference resulting from changes in the arrangement direction of the liquid crystal molecules.

The backlight unit 3300 may provide light from a back surface of the display panel 3210 to the display panel 3210. The backlight unit 3300 may include an optical assembly 3223 and a plurality of optical sheets 3225 positioned on the optical assembly 3223. The backlight unit 3300 will be described later in detail.

The display panel 3210 and the backlight unit 3300 may form a module using the cover 3230 and the bottom plate 3235. The cover 3230 positioned on a front surface of the display panel 3210 may be a top cover and may have a rectangular frame shape covering an upper surface and a side surface of the display panel 3210. An image achieved by the display panel 3210 may be displayed by opening a front surface of the cover 3230.

The bottom plate 3235 positioned on a back surface of the backlight unit 3300 may be a bottom cover and may have a rectangular plate shape. The bottom plate 3235 may serve as a base element of the display device 3200 when the display panel 3210 and the backlight unit 3300 form the module.

The driver 3240 may be positioned on one surface of the bottom plate 3235 by a driver chassis 3245. The driver 3240 may includes a driving controller 3241, a main board 3242, and a power supply unit 3243. The driving controller 3241 may be a timing controller and controls operation timing of each of driving circuits of the display panel 3210. The main board 3242 transfers a vertical synchronous signal, a horizontal synchronous signal, and a RGB resolution signal to the driving controller 3241. The power supply unit 3243 applies a power to the display panel 3210 and the backlight unit 3300. The driver 3240 may be covered by the back case 3250.

In accordance with one or more embodiments described herein, a network TV processing multiple applications and methods for controlling the same provide a solution related to an on-screen display (OSD) that can enable users to select and manage a gradually increasing number of downloaded applications more conveniently and efficiently.

According to another embodiment, a service may be provided that enables a network TV processing multiple applications to automatically categorize downloaded applications based upon a predetermined standard and to quickly access the categorized applications.

In accordance with another embodiment, a network TV processing multiple applications and a method for controlling the same may be realized as executable code that can be read by a processor provided in the image display device in a recording medium that can be read by a processor. The recording medium that can be read by the processor includes all types of recording devices storing data that can be read by the processor.

Examples of a recording medium that can be read by a processor may include ROMs, RAMs, CD-ROMs, magnetic tapes, floppy disks, optical data storing devices, and so on. Also, an exemplary recording medium being realized in the faun of a carrier wave, such as a transmission via Internet, may also be included. Also, the recording medium that can be read by a processor may be scattered within a computer system, which is connected through a network. And, code that can be read by the processor may be stored and executed by using a dispersion (or scattering) method.

One object that can be achieved by one or more embodiments described herein, therefore, is to provide a network TV processing multiple applications and a method for controlling the same can enhance user convenience.

Another object is to provide a solution enabling the user to more easily and efficiently select and manage the gradually increasing number of downloaded applications in the network TV processing multiple applications.

Another object is to provide a service that enables the network TV processing multiple applications to automatically categorize downloaded applications based upon a predetermined standard and to quickly access the categorized applications.

To achieve these objects and/or other advantages, one embodiment relates to a method for controlling a network TV processing multiple applications includes the steps of receiving broadcast data including audio data and video data through a broadcast network, demultiplexing the audio data and the video data included in the received broadcast data, decoding the demultiplexed audio data, decoding the demultiplexed video data, downloading at least one or more applications through an Internet network, when a first input signal is received, generating at least one or more display areas each corresponding to a respective number of the downloaded application, displaying image data indicating a specific application and a unique number corresponding to the specific application in each of the generated display areas, and, when a second input signal for selecting the unique number is received, controlling the network TV so that the specific application can be executed.

Another embodiment relates to a network TV processing multiple applications includes a broadcast network interface configured to receive broadcast data including audio data and video data, a demultiplexer configured to demultiplex the audio data and the video data included in the received broadcast data, an audio decoder configured to decode the demultiplexed audio data, a video decoder configured to decode the demultiplexed video data, an Internet network interface configured to receive at least one or more applications, a memory configured to download the received at least one or more applications, an on-screen display (OSD) generator configured to generate at least one or more display areas, each corresponding to a respective number of the downloaded application, when a first input signal is received through a user interface, a display module configured to display image data indicating a specific application and a unique number corresponding to the specific application in each of the generated display areas, and a controller configured to control the network TV so that the specific application can be executed, when a second input signal for selecting the unique number is received.

Another embodiment provides a method for controlling display of information, comprising: receiving first data indicative of a plurality of downloaded applications; displaying the first data in different areas on a screen of a display device, each area to display the first data of a corresponding one of the applications; assigning second data to the applications, the second data indicative of a different order or rank of the applications; displaying second data with the first data on the screen; receiving a signal selecting the second data corresponding to one of the applications; and executing the application corresponding to the selected second data, wherein the applications are stored in a storage area in the display device or a device coupled to the display device, wherein the display device is a television, and wherein the first data includes at least one of text, graphical objects, or images indicative of respective ones of the applications.

Another embodiment provides a television comprising: a screen; a first interface to receive first data indicative of a plurality of downloaded applications; and a processor to control display of the first data in different areas of the screen, to assign second data to the plurality of downloaded applications, and to control display of second data with the first data, wherein the processor further receives a signal selecting the second data corresponding to one of the applications and executes the application corresponding to the selected second data, and wherein: the applications are stored in a storage area of the television, each of the different areas displays the first data of a corresponding one of the applications, the first data including at least one of text, graphical objects, or images indicative of corresponding ones of the applications, and the second data is indicative of a different order or rank of the applications.

In accordance with any of the embodiments described herein, the network TV may be an intelligent display apparatus that is equipped with a computer supporting function in addition to the broadcast program receiving function. Accordingly, since the display apparatus is committed (or devoted) to its broadcast program receiving function and is also supplemented with an internet browsing function, the display apparatus may be equipped with an interface that can be more conveniently used as compared to an hand-writing type input device, a touch screen or a space remote controller.

Furthermore, being supported with a wired or wireless (or radio) internet function, the display apparatus may be connected to (or may access) the internet and a computer, thereby being capable of performing email transmission, web browsing, internet banking or gaming functions. In order to perform such variety of functions, the display apparatus may adopt a standardized OS for general purpose.

Accordingly, since a variety of applications may be easily added to or deleted from a network TV within an OS kernel for general purpose, the network TV described in the description of the present invention may, for example, be capable of performing a wide range of user-friendly functions. More specifically, examples of the network TV may include internet protocol televisions (IPTVs), hybrid broadcast broadband televisions (HBBTVs), smart TVs, connected TVs, and monitors, as well as other types of display devices.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. The features of one embodiment may be combined with the features of one or more other embodiments to form additional embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

We claim:

1. A method for controlling display of information, comprising:
receiving first data indicative of a plurality of downloaded applications;
displaying the first data in different areas on a screen of a display device, each area to display the first data of a corresponding one of the applications;
assigning second data to the applications, the second data indicative of a different order or rank of the applications;
displaying second data with the first data on the screen;
receiving a signal selecting the second data corresponding to one of the applications; and
executing the application corresponding to the selected second data,
wherein the applications are stored in a storage area in the display device or a device coupled to the display device, wherein the display device is a television, and wherein the first data includes at least one of text, graphical objects, or images indicative of respective ones of the applications.

2. The method of claim 1, wherein the signal selecting the second data is received from a remote controller.

3. The method of claim 1, wherein the first data is displayed in overlapping relationship with the second data for respective ones of the applications.

4. The method of claim 1, wherein the second data includes:
different numbers assigned to respective ones of the applications,
wherein the first data is displayed on the screen in sequential order based on the numbers assigned to the applications.

5. The method of claim 4, wherein the different numbers are assigned by a user based on a priority of importance of the applications corresponding to the different numbers.

6. The method of claim 4, wherein the signal selecting the second data includes a number assigned to the application corresponding to the selected second data.

7. The method of claim 1, wherein the second data is displayed adjacent the second data for respective ones of the applications.

8. The method of claim 1, further comprising:
receiving third data indicative of a status of each of the applications;
displaying the third data with first data and the second data on the screen,
wherein screen areas corresponding to applications having a first status are displayed differently from screen areas of applications having a second status.

9. The method of claim 8, wherein the first status is indicative of a favorite application and a second status is indicative of a non-favorite application.

10. The method of claim 9, wherein the second data corresponding to the applications having a favorite status are automatically assigned an order or rank higher than an order or rank of the applications having a non-favorite status.

11. The method of claim 9, wherein the applications having a favorite status are displayed separately from the applications having a non-favorite status.

12. The method of claim 1, wherein the first and second data corresponding to the applications are displayed in sequential order irrespective of status of the applications.

13. The method of claim 1, further comprising:
displaying first data of additional downloaded applications differently from the first data of applications that have been previously assigned second data.

14. The method of claim 13, further comprising:
receiving second data corresponding to one of the additional applications; and
displaying an area corresponding to said one of the additional applications between areas corresponding to two of the applications previously assigned second data.

15. The method of claim 1, further comprising:
receiving information dividing the applications in to groups; and
displaying the first and second data for the applications in different regions of the screen, each region corresponding to applications that belong to a same group.

16. A television comprising:
a screen;
a first interface to receive first data indicative of a plurality of downloaded applications; and
a processor to control display of the first data in different areas of the screen, to assign second data to the plurality of downloaded applications, and to control display of second data with the first data, wherein the processor further receives a signal selecting the second data corresponding to one of the applications and executes the application corresponding to the selected second data, and wherein:
the applications are stored in a storage area of the television,
each of the different areas displays the first data of a corresponding one of the applications, the first data including at least one of text, graphical objects, or images indicative of corresponding ones of the applications, and
the second data is indicative of a different order or rank of the applications.

17. The device of claim 16, further comprising:
a second interface to receive signals indicating the second data to be assigned to the first data indicative of the downloaded applications.

18. The device of claim 17, wherein the second interface is a remote controller interface.

19. The device of claim 16, wherein the second data includes:
a different number assigned to respective ones of the applications,
wherein the processor controls display of the first data on the screen in sequential order based on the numbers assigned to the applications.

20. The device of claim 16, wherein the signal selecting the second data is generated based on a position of a cursor overlying an area on the screen corresponding to the selected application.
